(19) United States
(12) Patent Application Publication
(10) Pub. No.: US 2015/0287133 A1
(43) Pub. Date: Oct. 8, 2015

(54) METHOD AND SYSTEM FOR REDUCING THE RISK OF ROBBERY/THEFT OF BANKNOTES

(71) Applicant: KELID IT AB, Sundbyberg (SE)

(72) Inventors: Joakim Marlov, Stockholm (SE); Dan Johansson, Balsta (SE); Kjell Lind, Balsta (SE); Ulf Rytterholm, Balsta (SE)

(21) Appl. No.: 14/443,060

(22) PCT Filed: Nov. 15, 2013
(86) PCT No.: PCT/SE2013/000175

§ 371 Date: May 14, 2015

(30) Foreign Application Priority Data
Nov. 15, 2012 (SE) 1200696-1

(51) Int. Cl. G06Q 40/02; G06Q 10/08; G07D 11/00

(52) U.S. Cl. CPC G06Q 40/02; G07D 11/0066; G07D 11/0009; G06Q 10/0832

(57) ABSTRACT

A method reduces the risk of robbery/theft, for example during transportation of banknotes or storage of banknotes. The method is performed before or during a transport from, or storage at the sender. A banknote that is intended to be locked is registered, read and/or imaged. The banknote identity is stored as a Banknote-ID. Auxiliary information is registered and/or generated at the sender. A locking/blocking request includes at least one banknote identity and auxiliary local memory, whereby the banknote is indicated as locked in the central server, after receiving the transport/storage at the receiver. An unlocking/relocking request can be sent to a central server and/or to a local memory; and the auxiliary information from the receiver is checked to determine if it fulfills the conditions set in the auxiliary information from the sender and/or the predetermined conditions stored in the central server.

### TECHNICAL FIELD

The invention relates to a method and system for secure handling of banknotes in order to reduce the risk of robbery/theft, for example of cash-in-transit (CIT) or of cash in storage, and also enable tracking of banknotes for the purpose of investigation, for example of economic crimes.

### TECHNICAL BACKGROUND

Banknotes are highly targeted by thieves and criminals. Substantial sums are stolen due to robbery of and theft from banks, cash-in-transit transports, shops and individuals. This often leads to a high risk situation and trauma for the people who are being robbed, close by or affected since weapons often are used. Hostage situations may arise, as well as reckless driving of escape vehicles etc. Substantial sums vanish when cash-in-transit vehicles or cash depots are robbed and there are also examples of legitimate CIT companies that have used their clients money for their own use as a credit buffer before the value of transported cash have been credited to the client that requested the CIT-service, which has resulted in large losses for the client when the CIT-company has become bankrupt/insolvent.

The reason why banknotes are so attractive to thieves is that a banknote is not currently linked to/associated with its owner, unlike e.g. a debit/credit card. This means that a stolen banknote can freely be used in a transaction without any risk of the crime being detected. A banknote/bill cannot currently be locked and/or traced like a credit/debit card. A banknote can, unlike a credit/debit card, be used by anyone without any form of proof of ownership, like identification, password, or signature. In addition, banknotes can be used without access to online verification services or advanced electronic equipment—unlike credit/debit cards. Banknotes also have the advantage of reducing the value at risk, since you cannot lose/get robbed of more cash than you have on your person nor can you spend more cash than you have at hand.

The technological maturity is very unevenly distributed globally. Some markets are more or less only using cash for payments. This means that banknotes with high probability still will be used in the future, even in the presence of digital cash and/or debit/credit cards.

Current methods and systems for reducing the risk of robbery, protecting cash in transit and protecting stored banknotes are lacking/incomplete and a constant arms race is going on between those who want to protect banknotes and those who want to steal them. Current methods in use include special safety security bags/cases/container that can be traced and that destroys and/or mark/taint the banknotes physically if the container is damaged. Other methods of protecting cash in transit are armored vehicles, which are in principle mobile vaults protected by armed guards with personal armor. Other methods in use includes cash registers where staff have restricted access to the banknotes as well as internal transfer of banknotes in, for instance, a department store when a cash register has a either a surplus or deficit of banknotes.

These methods do not prevent the risk of robbery which is clearly shown by the current news frequently reporting robberies of cash in transit, banks and shops. These robberies as well as the risk of robbery create physical and mental stress for all people involved in cash handling. There is a definite risk of personal injury when the robbery is executed as well as when potential police operations commence.

The mentioned methods do not help against so-called insider jobs. There are also cases when the cash-in-transit carrier company has failed to book the value of the transported money to the client/owner of the money followed by the bankruptcy of the CIT company leading to the client losing their money.

With the current methods it is also very difficult to detect when stolen cash is getting into circulation. Even if a suspected criminal is caught possessing a large amount of banknotes it can be very difficult to tie the criminal to a specific crime since the banknotes can come from other sources/activities.

There have been many attempts to solve these problems. For example, the patent publication DE10107344 shows a method to detect counterfeit banknotes, banknotes in circulation that have been included in a ransom and/or stolen banknotes. The method is based on the principle that all banknotes in the financial system gets a new identity marking in the form of a bar code, a microchip or a magnetic strip that allows a machine readout. This means that in order to take the method into use a basic requirement is that all of the banknotes in the financial system need to be altered and/or replaced. The method assumes that each banknote in the financial system has a registered owner where the owner and the ownership are stored in a database.

The disadvantages of this method include the fact that it assumes that all banknotes and their owners are registered in a database, which partly causes an unwanted intrusion into the privacy/anonymity of the individual, and the method requires that the method is introduced everywhere where these banknotes can change hands/ownership in a financial system and at the same time, and that all banknotes require a new type of identification which is practically impossible, and that the method excludes banknotes without a registered owner, and that each transaction where banknotes change hands require verification of ownership and update of the ownership of the database, and the current owner and the new owner of a banknote must be at the same physical location at the change of ownership. The method in this patent publication also does not show how to secure or lock banknotes before a cash-in-transit transport and/or during cash storage, and how to unlock/release the banknotes safely.

The patent publication DE19824435 discloses a method and apparatus for evaluating the authenticity, validity and identity of a banknote, and the possibility of comparing the identity of a banknote against a list of Banknote-IDs identified as stolen or specified as part of a ransom or extortion money. The method also allows one to register a banknote as belonging to a particular owner for use in the case of theft so one can inform the police which banknotes have been stolen.

The method does not show how to secure/lock banknotes before a transport and/or during storage, and how these banknotes then can be safely unlocked/released since the rightful receiver/future owner of the banknote is not specified nor do the banknotes have a registered owner during the whole or part of the cash-in-transit shipment.

Other disadvantages of this method is that anyone can register the ownership of a banknote or delete the ownership data in the memory devices, the method is based on a network of synchronized memories instead of a central server that provides control, tracking and alert/alarming services, the method thus lacks the ability to generate a central alarm when there is an attempt to circulate a stolen banknote somewhere in the system and the method also lacks the ability to allow circulation of banknotes that are registered for tracing/tracking purposes only and then generating a central alarm, the method also requires manual update of the memory units in order to register the identities of stolen banknotes.

The patent publication DE19530370 discloses a method and an apparatus for recording the identity of banknotes as they are put in a cash register and then the banknote's identity is compared with the contents of a memory where stolen Banknote-IDsentities are stored, and if the banknote's identity is found, it activates a signal.

The method does not show how to secure or lock banknotes before a cash-in-transit transport and/or cash storage, and how these banknotes then can be released/unlocked in a safe manner. The method in the patent publication is lacking a lock method, a release/unlock method and is also lacking a method/possibility to decide/verify which person or organization that has the legitimate right to release/unlock the banknotes.

Other disadvantages of this method is that anyone can delete the data in the memory devices, the method lacks a central server that provides control, tracking and alarm services, the method thus lack the ability to generate a central alarm when there is an attempt to circulate/turn over a stolen banknote in the system and the method also lacks the ability to allow the circulation of banknotes that are registered for tracing/tracking purposes only where a central alarm is generated if a traced/tracked banknote is detected, the method also requires manual updating of the memory devices in order to register the identities of stolen banknotes.

It is therefore desirable to find a solution that makes it possible to transport cash from a sender and/or storing banknotes safely in a manner that basically means that cash-in-transit/cash in storage are non-usable, until an intended recipient/owner of the cash “unlocks”/“releases” the banknotes.

Such a solution should not require any physical change of the existing banknotes in circulation, and the solution should be possible to put into use gradually without requiring the system to be implemented everywhere at once.

Such a solution will reduce the risk of assaults and threats, eliminate the need for special safety equipment such as safety bags/cases and armored cars as well as eliminate/reduce the need for security staff while transporting cash.

### KEY CONCEPTS AND DEFINITIONS

In this patent application a number of key concepts are frequently used. Listed below are the most important concepts and their definitions.

Sender—e.g. a store, bank, cash depot, cash exchange, a physical or legal person/entity etc, that intends to send banknotes to a receiver, for the purpose of payment, for storage, deposit or similar. A sender and receiver can be fundamentally the same entity, for example, when the purpose of using the system is that banknotes should be stored safely. A sender may preferably be identified by a Sender-ID.

Receiver—e.g. a store, bank, cash depot, cash exchange, a physical or legal person/entity etc, which receives and/or manages banknotes from a sender, e.g. as payment, for storage, deposit or similar. A receiver may preferably be identified by a Receiver-ID.

Transportation agent—one or more persons or a function/organization that performs the physical movement of banknotes/cash-in-transit between a sender and a receiver.

Transaction spot—e.g. a store or place where banknotes are changing hands/owners and/or are used as payment.

Banknote scanner—a scanning/detection unit/banknote reader that identifies, detects and/or records an image of a banknotes denomination, bill type/version, currency, identity/existing banknote number etc and converts these characteristics into digital information. A banknote scanner may also include a processor configured to form/create a Banknote-ID that is unique for every banknote, based on the digital information. Identification can e.g. be done through RFID, OCR, barcode scanning, QR codes, photography, etc. A banknote scanner may preferably be identified by a unique Banknote Scanner ID.

Central server—one or more computing devices which are adapted to receive, process, transmit and store information about the banknotes, banknote status, etc. The central server performs a number of services requested by the senders, receivers, sales locations/transaction spots, etc., and the services are invoked via some form of communication link e.g. using computer/mobile networks.

Communication unit—an unit/function to send/receive digital information preferably from/to the central server and via some form of network. Digital information can also be sent/received through removable physical media such as a USB flash drive or other storage media.

Banknote-ID—a unique combination of information that identifies a banknote, for example a banknote serial number or a banknote serial number with the denomination/currency, or a digitized image or checksum of the digital information associated with the banknote. The Banknote-ID is read/formed by/via a banknote scanner.

Banknote status—specifies e.g. if the banknote is tradeable, locked, stolen, marked for tracking/tracing etc within the system. A banknotes status can be obtained, for example by request to the central server, and/or changed/assigned via a request to the central server. Such a status may be e.g. implemented in the central server by storing the Banknote-ID in combination with a code in a register/database/memory, and/or that a Banknote-ID is stored in a specific location/table in a file/database/memory to the effect that all stored Banknote-IDs have an implicit status, or that the absence of a Banknote-ID in a register/table/database/memory implies an implicit status, for example that a banknote is tradeable/unlocked. Banknote-IDs and their status can also be copied to/stored in local memory devices.

Tradeable—meaning that a certain banknote will/can be accepted as payment.

Locked—meaning that a certain banknote is not tradeable, i.e. will not be accepted as payment/valid in the same way as banknotes that are stained with safety ink from ampoules from a violated/stolen safety bag/bank box/teller are not accepted.

Marked for tracking—a banknote status resulting in that the system will issue a warning/raise an alarm/create a log entry when a banknote with such a status is traded/detected.

Locking—to lock a banknote means the banknote is assigned a certain status with the implication that the banknote is not tradeable, and that the banknote has a related unlocking condition set.

Unlocking—to unlock a banknote means that the banknote is assigned a certain status with the implication that the banknote is tradeable.

Relocking—to immediately lock a banknote again after the banknote was unlocked, preferably with a new related unlocking condition set.

Alert, Alarm—generate information/a signal that enables people/systems to be aware that an transaction/attempted transaction with a locked banknote takes/took place.

Service request—a piece of information that contains at least one Banknote-ID, usually including an explicit request, auxiliary information and other necessary additional information. The other additional information can, for example, consist of a banknote scanner serial number/ID, date/time, person/user ID, company/customer ID, account number, Receiver-ID, Sender-ID and such. Service requests are transmitted to the central server where one or more actions are performed for/upon/in relation to the Banknote-ID that the service request is pertaining to.

Request—Specifies the action that the sender/receiver/transaction spot request to be performed in the central server for a Banknote-ID, for example a banknote status change/assignment. A request can be specified explicitly or implicitly. An implicit request may be done through a call to a service on a specific port or address of the central server where the port/address itself determines the action to be performed or where information in/a part of the service request indicates the action that should most likely be performed, such as if the service request is made by a sender then it can be assumed that the banknotes are to be locked and if the service request is made by a receiver then it can be assumed that the banknotes will be unlocked.

Auxiliary information—is a set of information that is transmitted along with one or multiple Banknote-IDs including a request to the central server in order to control how the central server should process each Banknote-ID, for example if the banknote should be locked, marked for tracking/tracing or unlocked.

Unlocking method (US1 and US2)—specifies what method/which technology to use (US1) to verify that a request for unlocking is valid, e.g. a certain certificate method like Bank-ID must be used, a password must be entered or such. The unlocking method may also be implicit. i.e. predetermined in the central server for example that the certificate method for set in/be derived by the unlocking information U1, e.g. “Bank-ID5564031234” could mean that a valid Bank-ID certificate for an organization with registration number 556403-1234 is required. The unlocking method is usually some form of identification, such as mobile banking ID, ID card with a chip, an ID box, biometric identification and/or a password. The unlocking method required for unlocking is indicated by US1 and is usually set by the sender and the unlocking method actually used, usually by the receiver, by an attempt/request to unlock is indicated by US2.

Unlocking condition (UV1)—consists of an unlocking method US1 and/or unlocking information U1. Several unlocking conditions may be combined to enhance security, for example that the banknotes must be scanned via a specified scanner and that the receiver identifies itself in a certain way, such as with a mobile banking ID, ID cards, passwords or similar. Several unlocking conditions UV1 can be specified as options, such that the recipient must identify themselves with a mobile banking ID or an ID card or a certain password. An unlocking condition UV1 can be entered directly/explicitly in a lock request, or can be pre-stored in, for example, the central server and referenced/related indirectly/implicitly by a locking request, for example, that a particular Receiver-ID is specified in the lock request, and in the central server there exists a pre-stored unlocking condition UV1 related to this Receiver-ID. Indirect/referenced/related unlocking conditions UV1 can be referenced/found via e.g. Receiver-ID, Sender-ID, banknote scanner ID, keys, timestamps/time intervals or combinations of similar information.

Unlocking verification (UV2)—consists of an unlocking method US2 and/or unlocking match-information U2. Several unlocking verifications UV2 can be combined to match combinations of or alternatives of unlocking conditions UV1. An unlocking verification UV2 can be entered directly/explicitly in one of the unlocking requests, or can be pre-stored in, for example, the central server and referenced/related indirectly/implicitly in the unlock request, for example, that for a particular Receiver-ID specified in the unlock request there exists an unlocking verification UV2 related to the Receiver-ID where the UV2 is pre-stored in the central server. Indirect/referenced/related unlocking verifications UV2 can be referenced/found via e.g. Receiver-ID, Sender-ID, banknote scanner ID, keys, timestamps/time intervals or combinations of similar information.

Unlocking information (U1)—is a set of information that is linked/related to one or more Banknote-IDs together with an unlocking method. The unlocking information U1, for example given by the sender, must match the information given in an unlocking match-information U2, for example given by the receiver at the request to the central server for unlocking one or more Banknote-IDs, in order for the unlocking request to be executed. The information in unlocking match-information U2 have/should have been generated/specified by the unlocking method specified in the unlocking condition UV1. The unlocking information U1 must be matched by the unlocking match-information U2 in order to unlock the specified Banknote-IDs. The unlocking information U1 can, for example, be a personal identification code, account number, customer number, engine serial number for a scanner, passwords or similar.

Unlocking match-information (U2)—is a set of information specified/generated/referenced/transferred with an unlock request for one or several Banknote-IDs. The match-information has been generated/entered by the unlocking method stated in the unlocking condition UV1. The unlocking match-information U2 must match the unlocking information U1 in order to fulfill the unlock request for the Banknote-IDs. In one embodiment of the invention the sender has locked a certain number of banknote-IDs with an unlocking condition UV1 indicating that a password must be entered (the unlocking method) and the password required is “Othello123” (U1). In one case the receiver unlocks the banknote-IDs by sending an unlock request for the banknotes and their banknote-IDs, and a password (U2) is specified explicitly, i.e. “Othello123”. In another case the receiver sends an unlock request where the password (unlocking match-information U2) is referenced/can be retrieved from the central server with the help of other information in the unlock request, e.g. Receiver-ID. In the latter case, there exists pre-stored information (unlocking verification UV2) preferably in the central server, which is related to this Receiver-ID. Indirect/referenced/related unlocking verifications UV2 can be referenced/found via e.g. Receiver-ID, sender-ID, banknote scanner ID, keys. timestamos/time intervals or combinations of

The first auxiliary information (T1)—contains at least one unlocking condition UV1 and/or information that is used to relate/refer/retrieve an unlocking condition UV1.

The second auxiliary information (T2)—contains at least one unlocking verification UV2 and/or information that is used to relate/refer/retrieve an unlocking verification UV2.

Unlocking instruction—the first auxiliary information T1 is required to lock a banknote and the second auxiliary information T2 is required for unlocking the banknote. In certain embodiments of the invention, an unlocking instruction is required to be communicated to the recipient, e.g. through a mobile phone call or email or such from the sender. The first auxiliary information T1 specifies which unlocking method and/or the information and/or the type of information required to unlock a banknote. The unlocking method and/or information requirements for unlocking can be “transparent”, such that the central server at the request of the receiver informs the receiver for example that a certain Banknote-ID can/must be unlocked via identification by a particular Bank-ID certificate or by answering a particular control question correctly. In other cases, the unlocking method/information requirement for unlocking might be “closed” so that the recipient is in no way informed by the central server which unlocking method and/or the type of information is required to unlock the banknotes, for example, the sender and receiver might have agreed on a predetermined password that must be submitted when unlocking banknote-IDs from that particular sender. The information about the requirements/method for unlocking a Banknote-ID where the unlocking method is “closed” constitutes an unlocking instruction.

Registration/generation of the first auxiliary information (T1)—created before/at/during the locking/tracking request for a Banknote-ID, for example by specifying that a certain receiver is defined and how the receiver must identify itself, or a password/other information selected/entered through an input device or read from a chip/magnetic card/memory or generated using a processor or retrieved from a digital service.

Registration/generation of the second auxiliary information (T2)—created prior to/at/in connection with the unlocking request for a Banknote-ID, for example by confirming a receivers identity or submitting a password/a set of information selected/entered through an input device or read from a chip/magnetic card/memory or generated using a processor or retrieved from a digital service.

Lock request—a service request with the intention to lock one or more Banknote-IDs in the central server with a direct/explicit or indirect/implicit/related unlocking condition UV1.

Unlock request—a service request with the intention to unlock one or more Banknote-IDs in the central server with an unlocking verification UV2.

Relock request—a service request with the intention to first unlock one or more Banknote-IDs with an unlocking verification UV2, then immediately lock these Banknote-IDs with a new related unlocking condition UV1.

Tracking request—a service request with the intention to assign/relate a status related/stored with one or more Banknote-IDs in the central server, indicating that the Banknote-IDs are to be tracked.

Control request—a service request with the intention to return/check the status of one or more Banknote-IDs in the central server.

### SUMMARY OF INVENTION

The objective of the present invention is to provide a method and a system that solves the problems mentioned above and which makes it possible to transport banknotes from a sender, such as a store/bank/cash dept/exchange office or similar, and/or store banknotes in a way that has the effect that the banknotes are not tradeable within the system until a specified recipient, e.g. a store/bank/cash depot/exchange office or similar, has acknowledged reception of/unlocked the banknotes.

An additional objective is that the system should make it possible to transport/store banknotes without any additional security measures, such as guards, armored vehicles, security bags/cases, etc.

An additional objective of the present invention is that the system should not require any

An additional objective of the present invention is that the system can be made operational gradually/progressively i.e. the system does not need to be implemented everywhere and at the same time. The system should be in operation for the participants/operators who has installed the method/system, without requiring that all market participants have joined the system or procured equipment.

An additional objective of the present invention is that when the banknote is locked, only the intended recipient or the person who can fulfill the unlocking conditions set forth in the first unlocking condition UV1 can unlock the banknote, which means it is not meaningful to attack or threaten the sender, or the transporter of the banknotes.

An additional objective is that the cost of security measures in connection with cash-in-transit and cash handling will be reduced significantly.

An additional objective is to reduce the risk of personal injury, both physical and mental, for the people who are involved in cash handling and cash-in-transit.

An additional objective of the system is that it should be possible to be implemented by simple means.

An additional objective is that the system is that it should be possible to introduce across national boundaries without fundamental changes.

An additional objective of the present invention is that it should not be possible to manipulate a shipment of banknotes, for example by replacing one or more banknotes in the shipment with other banknotes, such as forged banknotes, banknotes that have been stolen previously and/or locked banknotes etc.

These objectives are achieved according to the invention by a method, a system and a device mainly according to the features of claims 1, 21 and 25.

The invention is an integrated system. The invention consists of a comprehensive method and a comprehensive system. The various parts of the invention are intimately inter-dependent, integrated with each other and interact with each other. The invention works only under the condition that all the parts work together.

The comprehensive method consists of three interacting sub-methods and the comprehensive system consists of three interacting subsystems. The first sub-method and the first subsystem are intended to lock banknotes before or in connection with a banknote transport/cash-in-transit, i.e., when banknotes are sent from a sender to a receiver. The second sub-method and the second subsystem are designed to unlock banknotes when received by a receiver after a banknote transport/cash-in-transit. The third sub-method and the third subsystem are designed to allow the verification of whether a banknote is locked or tradeable/unlocked, for instance when paying for goods in a store.

When banknotes are transported, they are destined for a particular recipient. According to the method and system, the banknotes are locked during transport/cash-in-transit and not tradeable. This minimizes the risk of robbery and assault during transport/cash-in-transit and makes it possible for cash transportation to be performed very simply without any armored vehicles, special security bags/boxes, armed guards etc., which means that shipment of banknotes can be smooth, easy, risk-free and cost effective. The banknotes will be tradeable/unlocked only when the recipient has received the banknotes and someone with the proper credentials have unlocked the banknotes in the cash shipment.

### The First Sub-Method and Sub-System—Before Cash Transport

In conjunction with the preparation before transportation of banknotes or cash storage the banknotes existing and unique identification is detected by a reader/identification device, such as a banknote scanner or similar—as an example, if 100,000 USD in banknotes is sent from a sender, e.g. a store, to a receiver, such as a bank, the banknotes are scanned in the store and their banknote serial numbers and possibly other characteristics such as denomination, bill type, currency or such is read/scanned and stored locally and/or transmitted electronically to a central server/database/cloud service. The characteristics that make up a unique identification of the banknote is referred to as the Banknote-ID.

The locking of the banknotes is done by the sender in connection with the identification/scanning of Banknote-IDs, by entering/relating a registered/generated unlocking condition for these Banknote-IDs.

This unlocking condition is intended to be satisfied only by the intended recipient—an example of an unlocking condition might be that the recipient must acknowledge the reception of the banknotes with a code/password that the recipient is in possession of, or e.g. by entering a code via a specific device or by providing a specific keycard that the recipient has access to or some kind of electronic/digital identification of the recipient. In some special cases, one can also imagine that the banknotes can be unlocked by the sender and/or a third party—the unlocking condition can also in some special cases be defined by someone else than the sender. The person or persons/organizations that are able to meet unlocking condition are hereafter referred to as an “unlocker”. The specified unlocking condition can thus be likened to a “lock” that is defined by the sender and to which a specific “key” fits. The unlocking condition supplied when “locking” the banknotes is included in a “first auxiliary information”. Other information can be included in this first auxiliary information, such as account details where the value of the banknotes should be credited and/or to whom the banknote belongs right now, that is the owner of the banknote. Banknote-IDs and the first auxiliary information is transmitted electronically in a locking request sent to a central server, which registers that the banknotes with the specified Banknote-IDs are locked/not tradeable, and only can be unlocked, i.e. made tradeable, by fulfilling the specified unlocking condition.

When the Banknote-IDs and the associated first auxiliary information has been transferred to the central server, it is possible to safely transport the physical banknotes to the intended recipient since the transfer/locking request of the Banknote-IDs to/in the central server has locked the banknotes and marked them as non-tradeable. The banknotes are transported physically one way between sender and receiver, and information about the Banknote-IDs and the connected/related first auxiliary information is transferred another way digitally/electronically from the sender to the central server. Thereby a high security is achieved against attempts to use/circulate stolen banknotes, since a criminal must have not only the banknotes, but also be able to meet the precise unlocking conditions associated with the Banknote-IDs as well as the precise equipment to perform an unlocking attempt.

The banknotes are registered in the central server as locked/non-tradeable during cash-in-transit. If the banknotes are stolen or lost on their way to the receiver, the status associated with the banknotes will be “locked”/“non-tradeable”. This means that when someone tries to use one of the stolen/misplaced banknotes at, for example, a shop where the cash register is connected to the system, the Banknote-ID will be scanned upon acceptance, and a request will be sent to the central server to inquire about the status of the scanned Banknote-ID and a response is obtained in return which indicates whether the banknote is tradeable or locked/stolen. If a response is received that indicates that the banknote is stolen/not tradeable then one or more activities take place, such as the activation of an alarm, locking the cash drawer, taking a photo of the person who tried to use the locked/stolen banknote or similar activities. In a practical implementation of such a cash register system there probably exists a list/register of Banknote-IDs that are registered as stolen/locked and that transactions to the central server. Such a locally stored list/register can be updated in real time, periodically or as needed.

In some cases crime investigation authorities may wish to track banknotes, for example, when ransoms are paid, when identifying criminal networks or when mapping the flow of funds. Such banknotes must not be locked, but should be possible to circulate without raising the suspicion of the person submitting the banknote that the banknotes are tracked. When such a tracked banknote is circulated, for instance as payment in a store, and a request is made to the central server to check if the banknote is locked or not, there also occurs a check whether the Banknote-ID is marked for tracking or not. If the Banknote-ID is registered/associated with a status indicating that the Banknote-ID should be tracked, then the system can provide a central alarm and/or send a signal/information to the person responsible for monitoring/tracking of these banknotes. The system should not have a list of Banknote-IDs marked for tracking stored locally, for example in a cash register, since it might enable a criminal person/organization to access this information which may jeopardize an investigation.

### The Second Sub-Method and Sub-System—After Cash Transport

When a banknote transport/shipment is received, such as a shipment of banknotes arriving from a store to a bank, the Banknote-IDs are detected by a second reader/identification device, such as a banknote scanner or similar. The banknotes are locked during transport/cash-in-transit due to the process in the first sub-method/subsystem and the banknotes can only be unlocked by fulfilling the unlocking condition linked/related to the Banknote-IDs, stated in the first auxiliary information and stored in the central server. The receiver unlocks the banknotes by submitting/generating an unlocking verification, e.g. by a using a particular device or by using a specific key card that only the recipient has access to or using some form of electronic identification verifying the recipient, or by supplying a code/password that the recipient possesses. The unlocking verification submitted at the “unlocking” of the banknotes is included in a “second auxiliary information”. In this second auxiliary information other information can also be included, such as details of an account where the value of the banknotes should be credited. The purpose of the unlocking verification is to meet the specific unlocking condition which has been associated with the banknotes when they were locked at/before shipment/storage.

The unlocking is completed by sending the Banknote-IDs along with the second auxiliary information in an unlock request to the central server. The central server checks whether the unlocking verification in the second auxiliary information meets the unlocking condition stated in the first auxiliary information, for the banknotes that are requested to be unlocked.

If the unlocking condition is not met, then something has gone wrong, it could be an honest mistake, or an illegal attempt to unlock the banknotes. If the unlocking condition is not met, an alarm or other desired action can be initiated. The banknotes will still be locked.

If the unlocking condition is met, then the banknote's status in the central server changes, for instance by changing/updating a status code stored along with the Banknote-ID, or by deleting the Banknote-ID from a register/table/memory, or by moving the Banknote-ID to another register/table/memory—the meaning of this change, regardless of method, is that the banknote with the Banknote-ID is unlocked/tradeable.

In a practical implementation of this system/invention, one will rarely want to unlock banknotes. One option is that on receipt of the banknotes the recipient does not unlock the banknotes, but rather replace the previous unlocking condition with a new one, i.e. a “re-locking” of the banknotes—in this way it is possible to prevent a situation where the banknotes are unlocked at any moment within the system. An example of the usefulness of this process could be in a bank receiving a cash transport and when the banknotes have been acknowledged/checked against the central server by meeting the unlocking condition locked and safe during storage. In one embodiment of the invention it is possible to complement the unlocking condition with information about the individual/organization that owns the banknote at the moment. Another alternative to unlocking banknotes at/after reception is to postpone the unlocking until the receiver/owner chooses to forward them to a new recipient, and then probably choosing to specify a new unlocking condition for the banknotes.

In some special cases, one can also imagine that the banknotes can be unlocked by the sender and/or a third party—the owner of the money would e.g. be able to contact the shipper/third party and confirm that the banknotes has arrived safely at a destination, and then the transporter/third party unlocks banknotes by meeting the unlocking condition, e.g. by specifying a code or other method (see above). Such an unlocking procedure with a third party could be used to implement “escrow” in order to improve the security of a financial transaction between two parties.

### The Third Sub-Method and Sub-System—Checking Banknote Status

When a banknote is about to be used as payment in e.g. a shop, the status of the banknote is checked in the system to verify if the banknote is locked or tradeable/unlocked. The purpose of the status check is to prevent that locked banknotes could be used as payment. Since banknotes that are being transported, i.e. cash-in-transport, have been registered in the central server as locked/non-tradeable, it means that if the banknotes are stolen or disappear on the way to the receiver, then the banknotes status will still be “locked”/“non-tradeable”. This means that when someone that has a stolen and locked banknote in their possession and tries to put it into circulation, i.e. use it as payment, in a shop for example, then the Banknote-ID will be scanned at the cash register or equivalent, and a status control request for the Banknote-ID will be sent to central server and a response is obtained in return that indicates whether the banknote is tradeable or locked. If the response indicates that the banknote is locked/not tradeable then one or more activities take place, such as the activation of an alarm, the locking of the cash drawer, a photo is taken of the person who tried to use the banknote or other activities. In a practical implementation of such a cash register system, it is efficient to have a list/register of stolen/locked Banknote-IDs stored in a local memory in the cash register system in order to avoid unnecessary transactions to the central server. Such a list can be updated in real time, periodically or as needed.

In some cases of crime investigation authorities may wish to track banknotes, for example, when ransoms are paid, when identifying criminal networks or when mapping the flow of funds. Such banknotes must not be locked, but should be possible to circulate without raising the suspicion of the person submitting the banknote that the banknotes are tracked. When such a tracked banknote is circulated, for instance as payment in a store, and a request is made to the central server to check if the banknote is locked or not, there also occurs a check whether the Banknote-ID is marked for tracking or not. If the Banknote-ID is registered/associated with a status indicating that the Banknote-ID should be tracked, then the system can provide a central alarm and/or send a signal/information to the person responsible for monitoring/tracking of these banknotes. The system should not have a list of Banknote-IDs marked for tracking stored locally, for example in a cash register, since it might enable a criminal person/organization to access this information which may jeopardize an investigation.

Even if a person could get hold of locked banknotes e.g. by robbery or theft, and also have access to the necessary equipment and/or information to fulfill the banknotes unlocking condition, then these banknotes can be locked again as soon as the crime has been discovered, provided that transactions are logged in the central server, e.g. in chronological order, which creates a history of banknotes and their whereabouts, and from this history one can retrieve information about the banknotes that have been unlocked by a criminal act and use this information to lock the banknotes again. Such a history can be kept as long as desired/necessary.

When/if a banknote is accepted by the system as tradeable/acceptable, then the banknote is locked by sending a locking request, consisting of the Banknote-ID and an unlocking condition specified in a first auxiliary information, to the central server, which registers that the banknote with the specified Banknote-ID is locked/untradeable and that it can only be unlocked/become tradeable by meeting the specified unlocking condition. The unlocking condition can, in this example, be present in/supplied by the cash register, for instance by being pre-programmed in a chip, manually registered, downloaded over a network, fetched from a magnetic card or similar.

When banknotes are handed over as change e.g. from a cash register to a customer, then these banknotes are unlocked/made tradeable, before being given to the customer. This can be accomplished by scanning the banknotes and registering their Banknote-IDs, whereby the referenced Banknote-IDs and unlocking verification information in a second auxiliary information, provided by the cash register, is sent in an unlocking request to the central server which registers the banknotes as unlocked/tradeable—the unlocking verification supplied by the cash register when withdrawing cash will/should match the unlocking condition set by the same cash register when the cash was stored in the cash register, releasing the cash from the locked state in the cash register.

### Other

The system assumes that the banknotes can be identified in such a way that a comparison can be made between the banknote's unique identifier and identifiers stored/registered in the system. The identification does not necessarily have to be done by a scanning machine/device, but can also be done by manual registration via e.g. a keyboard, cell phone, a hand scanner, etc.

In a first embodiment of the invention the sender scans the banknotes that are about to be transported to a receiver and in conjunction with this scanning, the sender selects an unlocking condition (which is attached in the first auxiliary information) which can be a certain password (unlocking information) that should be given to/known by the recipient in advance or that the recipient is subsequently informed of/given access to. This unlocking condition is transferred along with the scanned Banknote-IDs preferably to the central server along with a request for locking, wherein the status associated with the specified Banknote-IDs is set as locked and the unlocking condition is stored in connection with the Banknote-IDs. When the banknotes arrive at the receiver the banknotes are scanned once again, and in order to unlock these banknotes the recipient submits a password (the “unlocking match-information” included in an “unlocking verification” attached in the “second auxiliary information”) which must match the password that the sender specified in the unlocking condition (enclosed in the “first auxiliary information”), and a request for unlocking is sent to the central server with the Banknote-IDs and the “second auxiliary information”. If the “unlocking match-information” in the “second auxiliary information” matches the “unlocking information” in the “first auxiliary information” the unlocking request will be executed, for example setting the status of the enclosed Banknote-IDs to unlocked/tradeable.

In a second embodiment, the sender scans the banknotes that are about to be transported to a receiver and in conjunction with the scanning, the sender selects an unlocking condition which states that the recipient must identify itself with a specific identity (the identity is the “unlocking information”) in a secure manner, such as by a certificate/Bank-ID (the “unlocking method”). This unlocking condition consists of “unlocking information” and “unlocking method” and is attached in the first auxiliary information, which is transmitted along with the scanned Banknote-IDs preferably to the central server, wherein the status associated with these Banknote-IDs will be specified as locked and the unlocking condition is stored in conjunction with the Banknote-IDs. When the banknotes arrive at the receiver the banknotes are scanned again, and in order to unlock the banknotes, the recipient must prove their identity (specified in the “unlocking match-information” submitted in the second auxiliary information) according to the method (“unlocking method”) that the sender specified in the first auxiliary information when the banknotes were locked). If the “unlocking match-information” match the “unlocking information” then the banknotes will be unlocked.

In a third embodiment, other unlocking conditions may be specified, for example that certain technical equipment, like a banknote scanner, which has a specified unique identity must be used for the scanning.

The principle is that the unlocking condition and the unlocking method, stated in the first auxiliary information, is determined/specified by the sender at the moment when the banknotes become locked, and the recipient must fulfill the unlocking condition by using the specified unlocking method to register/generate/assign certain information, which is supplied in the second auxiliary information, when the banknotes are about to be unlocked.

The main purpose of the first auxiliary information is to define who/what has the right to unlock the banknotes and/or how this should be done. The first auxiliary information is sent together with one or more Banknote-IDs from the sender (of the banknotes) to the central server.

The main purpose of the second auxiliary information is to prove/verify the authority/right to unlock one or more locked banknotes. The second auxiliary information is registered/generated when, in the normal case, a recipient intends to unlock a banknote/banknotes. The second auxiliary information is sent together with one or more Banknote-IDs from receiver (of the banknotes) to the central server. In a practical implementation the first and second auxiliary information is most likely encrypted with some form of digital certificate.

The “unlocking condition” submitted in the first auxiliary information and the “unlocking verification” submitted in the second auxiliary information constitutes a “combination” that can be likened to a lock and a key. When a banknote transport or storage of banknotes is initiated, the “unlocking condition” will constitute a digital lock that prevents the locked banknotes from being freely circulated/used as payment before this lock has been “unlocked”. This means that before banknote transport/storage, it is possible for the sender to create a unique digital lock for a certain banknote transport or to use a previously created lock. Each lock can be opened with a fitting digital key. This key is represented by the so-called “unlocking verification”. Each key can open one or more locks, each lock can be opened by one or more keys. A lock can be used by one or more different senders, and a key can be used by one or multiple receivers.

In a fourth embodiment, a given sender, such as a store, might use a unique lock that can be opened only by a specific receiver, e.g. by a particular key that a particular bank office has.

In a fifth embodiment, a given sender uses/specifies a unique lock that can be opened by multiple recipients, such as different offices of a bank chain, where these receivers have a common key. The essential part in this embodiment is that it does not matter to which physical bank office the banknotes are delivered as long as the value of banknotes are credited to the sender.

In a sixth embodiment, the banknotes are locked with a key that can be unlocked by an intermediary, such a clearing house, which has the authority to represent e.g. different banks.

In a seventh embodiment, a group of senders, such as a chain of stores, where each sender is using the same lock which in turn can be opened by a specific receivers, such as bank chains, common key.

A lock is a specification of an unlocking condition that must be met, and the key is the information that meets unlocking condition. This provides a wealth of opportunities for different implementations where e.g. one can use complex methods like digital asymmetric key systems available via chip card or certificate, or simple methods such as manual

An example of a digital analogy of the system's main principle, based on known technology used today, could be that a sender A wants to send a secret digital document to the receiver B. A encrypts the document with a key, and sends the document to B. A either communicates the key to B, or B already knows the key. B can thus decrypt the document when it is received. If the document would get in the wrong hands, the unauthorized cannot decode or unlock the information.

An example of a physical analogy might be that before the banknote shipment/transport commences, the sender places all banknotes in a lockable briefcase and then locks it with a key. The locked briefcase is sent to the recipient, and the recipient is in possession of a key that can open briefcase, or the sender have sent the key previously to the receiver or by a different route/courier than the briefcase is/was sent to the receiver—it is essential that the key and the briefcase are not sent at the same time and the same way.

In the present invention, security is much higher than in the above example because the banknotes exist as unique physical specimens and a person must have both gotten over the physical banknotes as well as the “unlocking match-information” which is required to unlock the banknotes and make them tradeable. Even if a person would come in possession of both the banknotes and the “unlocking match-information” or force a person with access to the “unlocking match-information” to unlock the banknotes, there will be a digital trace in the central server with the Banknote-IDs, and that information can be used to by e.g. a law enforcement agency to lock the stolen banknotes once again. The “unlocking information” is thus like a jigsaw piece that only fits with another jigsaw piece—the “unlocking match-information”.

The security in e.g. a shop where banknotes are received as payment and that give/return banknotes as change will, with this invention, be very high. When a banknote is received from a customer, the banknote is immediately scanned and a check is performed whether the banknote is tradeable or not, and there is an additional check in the central server to verify whether the banknote is marked for “tracking”, if so there will be a notification in the central server that a traced banknote has been detected, and predetermined or suitable measures will be taken.

If a received banknote is not locked, the banknote is immediately locked with an unlocking condition, and as a consequence all banknotes in the cash register are automatically locked after receipt. If the store is robbed then the stolen banknotes cannot be circulated/used as payment, since the banknotes will be detected in the system when someone is trying to circulate them/use them as payment, and furthermore the banknotes are possible to identify, for example at a house search or pat-down by scanning suspicious banknotes and checking the Banknote-IDs and their status in the central server.

When a customer gets back one or more banknotes as change, the banknotes are immediately unlocked by scanning the banknotes given as change, and the Banknote-IDs are sent along with an unlocking verification to the central server where the request to make the banknotes unlocked/tradeable is performed. If e.g. a robber would force a cashier to unlock the banknotes, there will still exist a digital track of the Banknote-IDs that can be used to relock the stolen banknotes, for instance by/when notifying a law enforcement agency. One can also imagine a scenario where you do not want to sound the alarm openly when a banknote marked as locked/tracked is encountered, e.g. during reconnaissance work looking for stolen money or ransoms, and e.g. use a camera connected to the cash register in order to discretely take a photograph and/or record a video of the person that paid with the banknotes, and if any banknotes were received as change then the Banknote-IDs of the banknotes constituting the change can in turn be marked in the system as “traced”, in order to be able to continue covert tracking of the Banknote-IDs, by registering the Banknote-IDs of the change banknotes as “traced” in the central server instead of being registered as tradeable/unlocked. Even if a person were able to exchange a major amount of such banknotes marked as “tracked”. A tracked 100 USD banknote, might have been changed into five 20 USD banknotes, and as a consequence the change will also be marked as tracked. You can of course get less change back than the full amount of the tracked banknote, or change smaller denominations into larger denominations—even this change can be traced through the above process.

The “unlocking condition” and the “unlocking verification” can e.g. be pre-stored in the cash register, be stored on a chip card that the cashiers use to “sign in” at the cash register, or similar.

This means that banknotes circulating in a system according to the invention are both locked during transport and during storage. The personal safety for people/staff working with cash becomes very high since it is pointless for a robber to force people to hand over banknotes and/or the unlocking codes, also known as the “unlocking verification”.

The communication between the sender and the central server, the receiver and the central server and the cash turnover point and the central server should be using a secure method such as a communication protocol that uses certificates and encrypted keys.

Even in the case where a robber has stolen banknotes and traded/given them to a private person or a company/business that is not connected to the system, then these stolen banknotes will be identified as soon as they are detected/circulated within the system. Even if a person has received the stolen banknotes in good faith, the criminal investigation will be significantly facilitated since you can interrogate/ask the receiving person about who gave the receiver the banknotes.

It becomes virtually impossible to put a large amount of stolen money into circulation—if a decoy is employed, the decoy will not be credible if he/she claims that he/she can not specify/remember where the stolen money comes from. Although a large amount of stolen money could be transacted through multiple decoys/middlemen in smaller amounts, the decoys will be tracked geographically as well as having their social network investigated which ultimately will facilitate the identification of the criminals/robbers

In cases where stolen banknotes are used to purchase capital goods, the seller will ultimately request that the banknotes that make up the payment are scanned at e.g. a bank to check if they are unlocked/tradeable. In cases where the seller did not check the banknotes constituting payment, it will often be possible to trace the goods in itself, such by registration numbers or similar.

Even if a criminal is careful and only makes small purchases with the stolen banknotes, gradually a geographic pattern will be discerned where the stolen banknotes are sooner or later put into the system, which ultimately will help to identify the criminal.

A robber that have been imprisoned and where the loot/bank notes have not been recovered will not be able to complete the prison sentence and then use the loot/banknotes when he/she is released, and additionally, relatives and/or friends will not be able to use the loot/banknotes since the banknotes are still locked.

If a robber would travel abroad with banknotes and try to use them with a foreign bank or an exchange office, even these banknotes will sooner or later be recognized by the system and a criminal investigation can be facilitated. When exchanging larger amounts abroad, one can imagine that the exchange offices who are not connected to the system can check random banknotes in larger sums received by sending a request to the central server where you enter Banknote-IDs and get an answer as to whether the banknote is tradeable or locked.

The invention makes it possible to use banknotes as an anonymous and flexible payment method without violating personal privacy yet still allowing tracking/locking of banknotes

One embodiment of the invention is that only the banknotes that are locked/during transport will be registered in the system database. Another embodiment is that all banknotes in circulation are recorded in the system database with a status indicating whether the banknote is tradeable, locked, stolen, traced, etc. In such an implementation, one can also identify duplicates/fakes. The status of a banknote can be of many different types—for instance meaning that the banknote is stolen, during shipping/in transport, in escrow, non transferable between specified times, lost, owned, existing in a cash register, stored in a safe, etc. The main thing is that there is a status indication that is connected to the banknotes unique identification (Banknote-ID) and where this link/connection is registered in e.g. a central server.

The system can e.g. keep track of the banknotes in a particular ATM/automated teller machine/cash dispenser/cash deposit machine. When the ATM is loaded with new banknotes or a banknote is loaded in the case of a cash deposit machine, then all the banknotes present in the machine are marked as locked. When a banknote is dispensed to a customer, the banknote is unlocked by scanning the Banknote-ID and issuing an unlock request, as in the case when banknotes are given out from a cash register. If someone breaks into an ATM and steals the banknotes, the system knows which banknotes were stolen and they are also locked/not tradeable.

Banknotes are moved in different cash transport streams. Wherever the banknotes reside in these feeds, the system can keep track of them and their status. It does not matter if a cash register, security transport, bank, cash depot, banknote producer, etc. is robbed, still the banknotes are marked as stolen/locked and will be detected when someone tries to use the banknotes

Since the system has control over which banknotes are a part of e.g. a cash transport batch, any form of manipulation of the batch can be detected upon receipt of the batch, such as if a banknote has been removed, been added or swapped

In cases where banknotes are used to make payments directly between individuals, checking can be done by Internet or equivalent to see if the banknotes used for payment are locked. It is possible to have a service offered by a bank or store where the status of a banknote can be checked, e.g. for instance in the case of a large cash transaction between individuals, such as a car purchase where the buyer's banknotes are checked by the seller before they are accepted as payment.

The system can also be used to lock banknotes during a given time period. It scans the banknotes and the Banknote-IDs and utilizes the system's locking functionality by specifying a date/time-limit in the unlocking condition, such as the date/time when the banknotes should be unlocked or that a certain time period should have passed before an automatic unlocking of the banknotes is performed in the central server when the date/time/time period has passed/elapsed. In this case no scanning of the banknotes is done by the receiver, nor is an unlocking verification needed/specified.

A similar function can be implemented at e.g. ATMs to protect against muggings, i.e. the possibility to request that the delivered banknotes are locked for a certain time period so that the receiver can get home or to the person/place that is to receive the banknotes.

The principal use of the invention is to prevent the theft of banknotes. The invention can additionally be used to establish control on virtually anything that is uniquely identifiable and that does not have a registered owner—e.g. a bank check, traveler's check, etc.

### Benefits

Benefits of the present invention include:

significantly reduced risk for theft of banknotes during transportation or storage since the banknotes are locked/non-tradable and can be tracked at the attempt of turnover which makes stolen banknotes practically unusable

reduced risk of personal injury since the theft of banknotes is no longer attractive

reduced risk that people will be harmed either physically and/or mentally in a robbery/attempted robbery

police, security guards, etc. can let a robber escape if there is a risk of personal injury, since the loot is locked/not tradable and will sooner or later be identified when an attempt to put banknotes in circulation is made

reduced costs in society for handling banknotes through reduced need for special security personnel, safety equipment, special vehicles etc. during handling, storage and transportation of banknotes

the threat against staff is greatly reduced when a robber cannot force the sender and/or transporter to unlock the banknotes

the threat against staff is greatly reduced when the robber cannot force the unlocking of banknotes without leaving digital traces in the system

banknotes can be automatically inhibited/locked during a given time period

stolen and locked banknotes become worthless in the invented system

stolen and locked banknotes can be tracked

the method does not require any physical changes to the existing banknotes and locking/tracing cannot be detected on the physical banknote

the system and method can be introduced gradually, meaning that all the participants in a “market” where a certain currency in banknotes are handled do not need to be connected to the system from the beginning

the system and method does not need to be fully implemented in the market to sort out crime since the banknotes are sooner or later detected in/by the system

the system and method can be implemented globally with different currencies

cash carriers/transporters can immediately, at the pickup of the banknotes at a customer or at the end of transport, credited the customer's account the amount provided by the customer to the cash transporter

money laundering is hampered/becomes harder

cash seized in connection with e.g. a house warrant or a pat down can easily be checked, in order to see if the encountered banknotes is part of known stolen goods, and thus beginning to unravel the crime

investigation of criminal offenses involving larger cash amounts can be facilitated by employing banknotes marked for tracing and then monitor where, when, and how the tracked banknotes are detected in the system

banknotes as part of a ransom can easily be recorded/scanned regardless of demands on mixed denominations, different currencies, broken banknote number series and such

### LIST OF FIGURES

FIG. 1 shows a block schematic diagram of the exchange of information associated with a physical banknote transport and/or with the circulation of a banknote.

FIG. 2 shows examples of service requests, i.e. information that is sent from senders, receivers and transaction spots to the central server.

FIG. 3 shows the variety and diversity of devices and users that may be connected to the system.

FIG. 4 shows the principles of a method and a system for transporting money/banknotes from a sender to a receiver, for example from a store to a bank, where the system and method makes the money/banknotes unusable if stolen/lost before they have been received and acknowledged/unlocked by the receiver. The figure shows the normal cases when no mishaps occur during transport, and the money/banknotes reach the receiver which acknowledge/unlock them.

FIG. 5 shows the same method as FIG. 4 but where a robbery takes place during transit, and the money/banknotes never reach the receiver, which results in that the robber cannot use the money/banknotes.

FIG. 6 shows a schematic diagram of a robbery/burglary/theft committed against a store/bank/cash depot or similar, where the robber at a later time attempts to use the stolen money/banknotes.

FIG. 7 shows a schematic diagram of how banknotes are registered/scanned and subsequently tracked, for instance when the banknotes are part of a ransom, and where an attempt to use the banknotes as payment is made.

FIG. 8 shows a flow chart of an embodiment of the invention regarding the procedure for a normal cash transport between a sender and a receiver.

FIG. 9 shows a flow chart of an embodiment of the invention regarding the procedure for using a banknote as payment, for example in a store.

FIG. 10 shows a block schematic diagram of banknote scanner according to the invention.

FIG. 11a shows an example of a data record in the central server for a banknote.

FIG. 11b shows an example of a batch data record and a banknote data record in the central server.

### DESCRIPTION OF PREFERRED EMBODIMENTS

The invention relates to a method and system for reducing or eliminating the risk of robbery/theft of banknotes, for example during cash-in-transit (CIT) or banknote storage, by locking the banknotes during transport and by checking the banknotes when attempting to use the banknotes for payment, and other means.

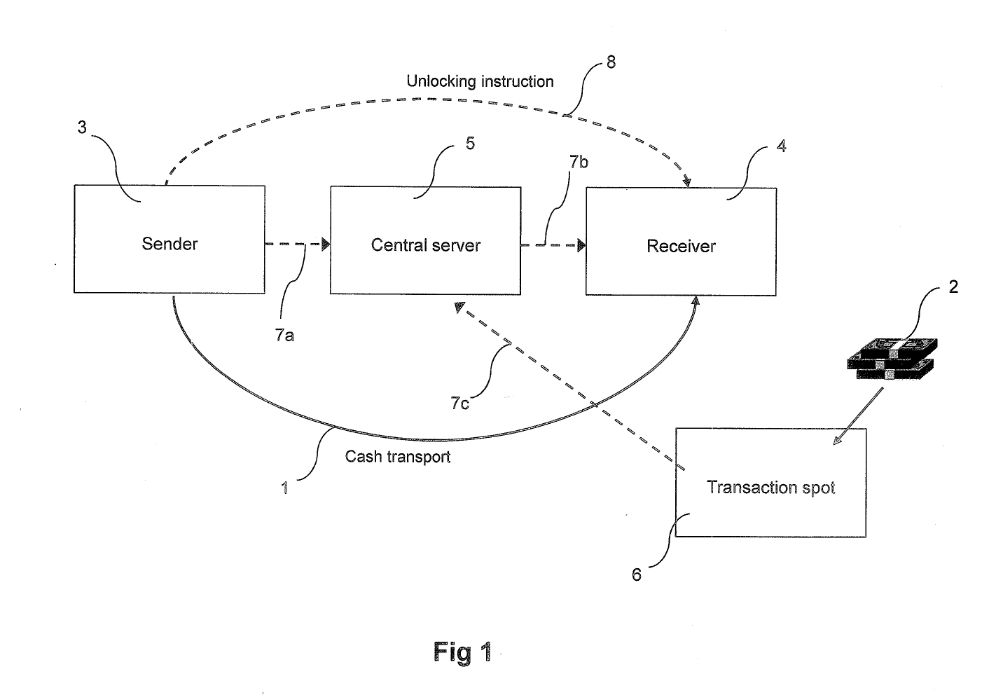

FIG. 1 shows a block schematic diagram of the exchange of information associated with a physical banknote transport 1 and/or with the circulation of a banknote 2.

The blocks shown are the sender 3, receiver 4, central server 5, and a transaction spot 6, for example a store.

The sender 3, receiver 4 and transaction spot 6 send and receive information to/from the central server 5. The information sent to the central server 5 normally includes a service request 7a, b, c, and one or several Banknote-IDs.

The most common information transmitted from the sender 3 to the central server 5 is a service request 7a in order to lock one or more Banknote-IDs. The most common information transmitted from the receiver 4 to the central server 5 is a service request 7b unlocking one or several Banknote-IDs. The most common information transmitted from the transaction spot 6 to the central server 5 is a service request 7c for checking the banknote status for one or several Banknote-IDs.

The sender 3 transmits the digital information to the central server 5 preferably before the physical transport of banknotes 1 starts between sender 3 and receiver 4. The digital information 7a follows one path and the physical banknotes 1 follows a different path. In an example of an embodiment, the unlocking instruction 8 can be transmitted from the sender 3 to the receiver 4 before, during, together with or after the transportation of the physical banknotes 1.

When an attempt is made to circulate/use a banknote 2 as payment, the transaction spot 6 communicates with the central server 5.

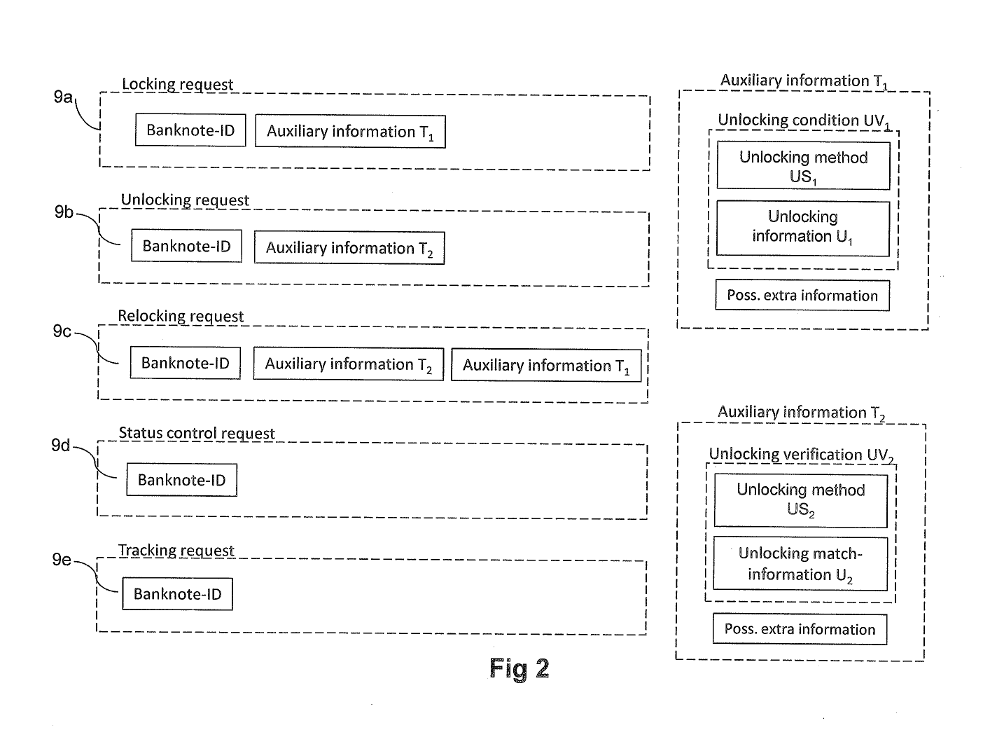

FIG. 2 shows examples of service requests, i.e. information that is/can be sent from a sender 3, a receiver 4 and a transaction spot 6 to the central server 5.

Senders 3, receivers 4 and turnover spots 6 send various types of service requests to the central server 5. The most common types of service requests 7a-c are the locking request 9a, the unlocking request 9b, the relocking request 9c, the status control request 9d and the tracking request 9e.

A service request 7a-c typically contains information about one or more Banknote-IDs and any auxiliary information that is relevant to the particular type of service request that will be performed.

The auxiliary information T₁ contains at least information defining an unlocking condition UV₁. The unlocking condition UV₁ consists of an unlocking method US₁ and/or unlocking information U₁. T₁ may contain additional information such as Date, Time, Sender-ID, Receiver-ID, etc.

The auxiliary information T₂ contains at least information defining an unlocking verification UV₁. The unlocking verification UV₁ consists of an unlocking method US₂ and/or an unlocking match-information U₁. T₂ may contain additional information such as Date, Time, Sender-ID, Receiver-ID, etc.

A locking request 9a, usually transmitted from a sender 3, contains at least one Banknote-ID and auxiliary information T₁ in order to lock one or more banknotes in the central server 5

An unlocking request 9b, usually transmitted from a receiver 4, contains at least one Banknote-ID and auxiliary information T₂ with the aim of unlocking one or several banknotes in the central server 5 with an unlocking verification UV₁ specified in T₂.

A relocking request 9c, usually transmitted from a receiver 4 or transaction spot 6, contains at least one Banknote-ID, and auxiliary information T₂ and T₁ with the aim of first unlocking one or several banknotes in the central server 5 with an unlocking verification UV₁ given in T₂, and then immediately after, or simultaneously, locking the banknotes in the central server 5 by defining a new unlocking condition UV₁ specified in T₁.

A status control request 9d, usually transmitted from a transaction spot 6, contains at least one Banknote-ID in order to obtain a response containing a possible banknote status related to/stored for the Banknote-ID.

A tracking request 9e is usually initiated for the purpose of tracking banknotes related to some criminal activity, and contains at least one Banknote-ID in order to mark the Banknote-ID for tracking/tracing in the central server 5.

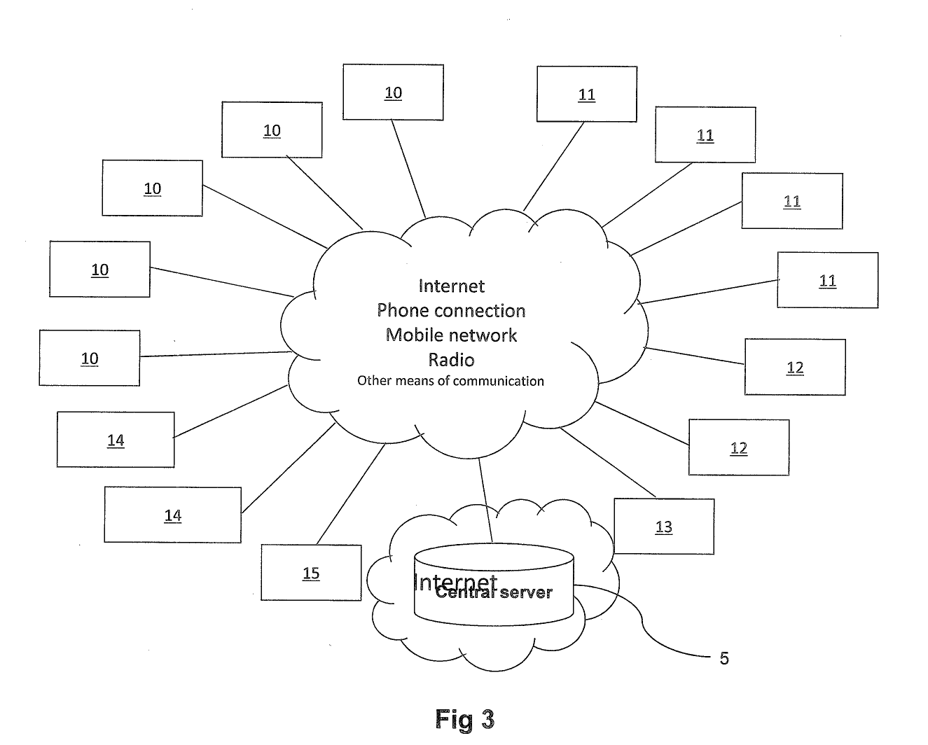

FIG. 3 shows the variety and diversity of devices and users that may be connected to the system.

These devices and users communicate, for example, over the Internet, mobile networks, fixed networks, radio communication, and direct point-to-point connections or by other types of data communication. Users connected to the system can be stores 10, banks 11, cash depot 12, individuals 13, exchange offices 14, authorities 15 etc. The devices connected to the system can be currency counters, cash-recycling machines, cash registers, mobile terminals, cash management systems, computers, voice recognition systems, etc. Users and devices exchange data with the central server 5. The central server 5 may consist of multiple computing devices or similar located in the same physical space and/or being geographically separated, where each computing device can include information about all Banknote-IDs or a subset of these. The actual configuration of the central server 5 is dependent on the need of/desired level of performance, redundancy, protection, security and such.

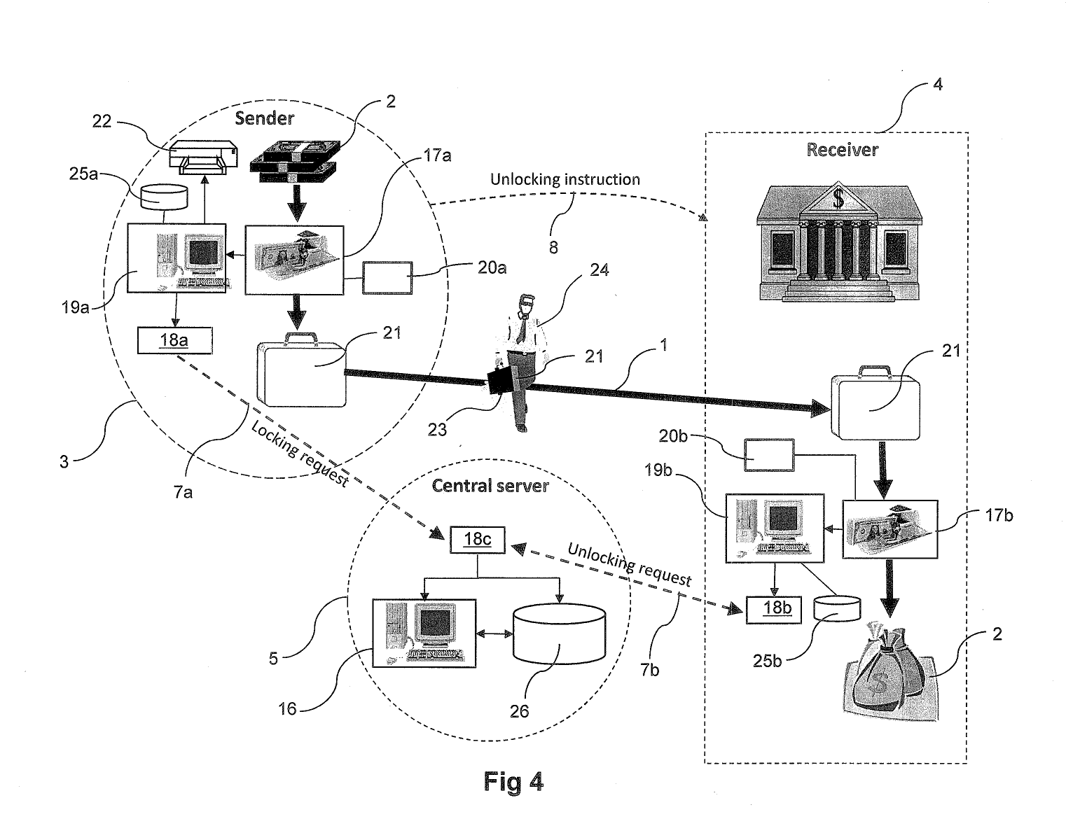

FIG. 4 shows the principles of a method and a system for transporting money/banknotes 2 from a sender 3 to a receiver 4, for example from a store to a bank, where the system and method makes the money/banknotes 2 unusable if stolen/lost before they have been received and acknowledged/unlocked by the receiver 4. The figure shows the normal cases when no mishaps occur during transport, and the money/banknotes 2 reach the receiver 4 which acknowledge/unlock them.

The system consists of a sender 3, a receiver 4 and a central server 5. The sender 3 may be a shop, bank, cash dept, exchange office or such, as well as the receiver 4. The central server 5 may include a computer 16, several computers, a cloud service or similar.

The sender 3 is provided with a reading device/banknote scanner 17a, such as a fast scanner or camera, which can be stationary or mobile. The reading device/banknote scanner 17a includes or is connected to a communication device 18a, by which the reading device/banknote scanner 17a can send and receive information to/from the central server 5. The reading device/banknote scanner 17a is arranged to at least scan or make an image of a banknote 2. The banknote's 2 identity, its Banknote-ID, can be identified (for instance by OCR-processing) either directly in the reading device/banknote scanner 17a or in another connected computing device 19a, or identified later. A banknote's 2 unique identity normally consists of a serial number but can also include the denomination and/or currency type and/or bill type/version and/or other information that can be used to uniquely identify and distinguish multiple banknotes 2 from each other. The reading device/banknote scanner 17a has a high capacity and can be read/scan many banknotes 2 rapidly. The reading device/banknote device may possibly be replaced/supplemented by the computer unit 19a, by which a first auxiliary information T₁, comprising an unlocking method US₁ and unlocking information U₁ (together constituting an unlocking condition UV₁), is registered and stored with/related to each respective Banknote-ID.

A service request 7a which includes at least one Banknote-ID and a related first auxiliary information T₁ is transmitted wirelessly or by wire to a central server 5. This service request 7a may include a locking request 9a with the intention to lock the banknote 2. This data set can also contain an account number, the sender's identity, scanner ID, date/time, etc.

The physical banknotes 2 which in the above manner have been recorded/registered are placed in an appropriate transport device 21, such as a sack or a bag, which thus constitutes a shipment/transport 1 of banknotes 2. A printer 22 is preferably arranged to print a receipt and/or a marking label 23 which may contain information about the shipment 1, and where especially the marking label 23 can be clearly colored, e.g. red, orange, fluorescent yellow, or such. The receipt/marking label 23 is included in the shipment 1, and the marking label 23 can be attached to the shipment 1 thus clearly indicating that the contents of the shipment 1 consists of locked banknotes 2 which are not tradeable. The banknotes 2 are transported by a carrier/courier 24, which transports the banknotes physically from the sender 3 to receiver 4.

The receiver 4 is provided with a reading device/banknote scanner 17b. The reading device/banknote scanner 17b includes or is connected to a communication device 18b by which the reading device/banknote scanner 17b can send and receive information to/from the central server 5. The reading device/banknote scanner 17b is arranged to at least scan a banknotes unique identifying features, usually the serial number, denomination and currency. The reading device/banknote scanner 17b includes or is connected to a registering device 20b directly/indirectly, by which a second auxiliary information T₂, comprising an unlocking method US₂ and an unlocking match-information U₁ (together constituting an unlocking verification UV₁), is registered/listed/generated/referenced. The registering device 20b may possibly be replaced/supplemented by the computer unit 19b.

A service request 7b which includes at least a Banknote-ID and a related second auxiliary information T₂ is transmitted wirelessly or by wire to a central server 5. This service request 7b may include an unlocking request 9b with the purpose of unlocking the banknote. This service request 7b may also contain an account number, the receiver's identity, scanner ID, date/time etc.

The physical banknotes 2 thus registered and preferably unlocked can be placed in suitable storage space, such as vault or safe.

The central server 5 may be a computer 16, several computers, a cloud service or similar. The central server 5 contains or is connected to a communication unit 18c. The central server 5 is arranged to transmit and receive information from senders 3 and/or receivers 4 of banknotes 2. The central server 5 is adapted to store information in a central memory 26, such as a database. Information sent from a sender 3 usually involves a service request 7a with the intention of locking of one or more Banknote-IDs. Information sent from a receiver 4 usually involves a service request 7b with the intention of unlocking one or more Banknote-IDs. The information in the service request 7a, a lock request 9a, usually contain a first auxiliary information T₁ indicating an unlocking method US₁ and unlocking information U₁ which together form an unlocking condition UV₁. The information in the unlocking request 9b usually contains a second auxiliary information T₂ indicating the unlocking method US₂ and unlocking match-information U₁ which together form an unlocking verification UV₁. The unlocking match-information U₁ from UV₁ must match the unlocking information U₁ from UV₁ and the unlocking method US₂ must match the unlocking method US₁ in order for the unlocking request 9b to be executed.

Another example is that the sender 3 does not specify an explicit unlocking method US₁ in the unlocking condition UV₁, thus eliminating the necessity of an unlocking method US₂ in the unlocking verification UV₁

Another example is that the sender 3 does not specify an explicit unlocking condition UV₁ in a service request 7a because the system is configured to connect/relate pre-stored unlocking conditions in the central server 5 to Banknote-IDs, such as that a particular Receiver-ID has a predetermined/pre-stored unlocking condition UV₁. In this example, the Receiver-ID must be included in the first auxiliary information T₁ in order to determine/retrieve the pre-stored unlocking condition UV₁.

Another example is that the receiver 4 does not specify an explicit unlocking verification UV₁ in its service request 7b because the system is configured to connect/relate pre-stored unlocking verifications UV₁ in the central server 5, for instance that a particular Receiver-ID has one or more predetermined/pre-stored unlocking verifications UV₁. In this example, the Receiver-ID must be included in the second auxiliary information T₂ in order to determine/retrieve one or several pre-stored unlocking verifications UV₁ One can equate such a pre-storage of unlocking verifications UV₁ with that the receiver 4 in the example has access to a prestored “key ring”. The system can be configured such that e.g. a main bank office has permissions, i.e. pre-stored unlocking verifications UV₁, as a proxy for unlocking banknotes for several regional branches, and in a service request 7b for unlocking bank notes the main bank office only need to specify their Receiver-ID in the second auxiliary information T₂ regardless of which regional branch office that the banknotes originally are locked/destined for.

The central server 5 stores, among other things, information regarding the Banknote-IDs and their related status as well as any unlocking conditions UV, linked to the Banknote-IDs. The unlocking conditions UV₁ may e.g. be stored per Banknote-ID, or as records related to Banknote-IDs, such as a batch data record containing common unlocking conditions UV₁ for a number of Banknote-IDs.

In an example where the system is implemented using batch data records, it is also possible to implement batch unlocking by supplying Batch-ID in an unlocking request 9b, rather than supplying specific Banknote-IDs, and the Banknote-IDs that are related to this Batch-ID will be unlocked provided that the unlocking condition UV₁ stored with/related to the Batch-ID is met with a matching unlocking verification UV₁.

One can thus summarize the invention in FIG. 4 by the following method steps taking place before/during a transport from the sender 3 or before storage at the sender 3:

recording/reading/imaging of a banknote 2 intended to be locked,

determination of the banknote's 2 identity, into a so-called Banknote-ID,

registration/generation of a first auxiliary information T₁ at/by the sender 3, comprising at least information about a predetermined receiver 4 such as the receivers 4 identity, account information or other, alternatively a key, code and/or other unlocking conditions UV₁ that must be satisfied/fulfilled in order to unlock or relock the banknote 2,

generation of a lock request 9a including at least one banknote's 2 identity, and the auxiliary information T₁,

transfer of the lock request 9a to a central server 5 and/or a local memory 25a, whereby the banknote 2 is indicated as locked in the central server 5,

reception of the lock request 9a in the central server 5 including banknote 2 identity, and the auxiliary information T₁,

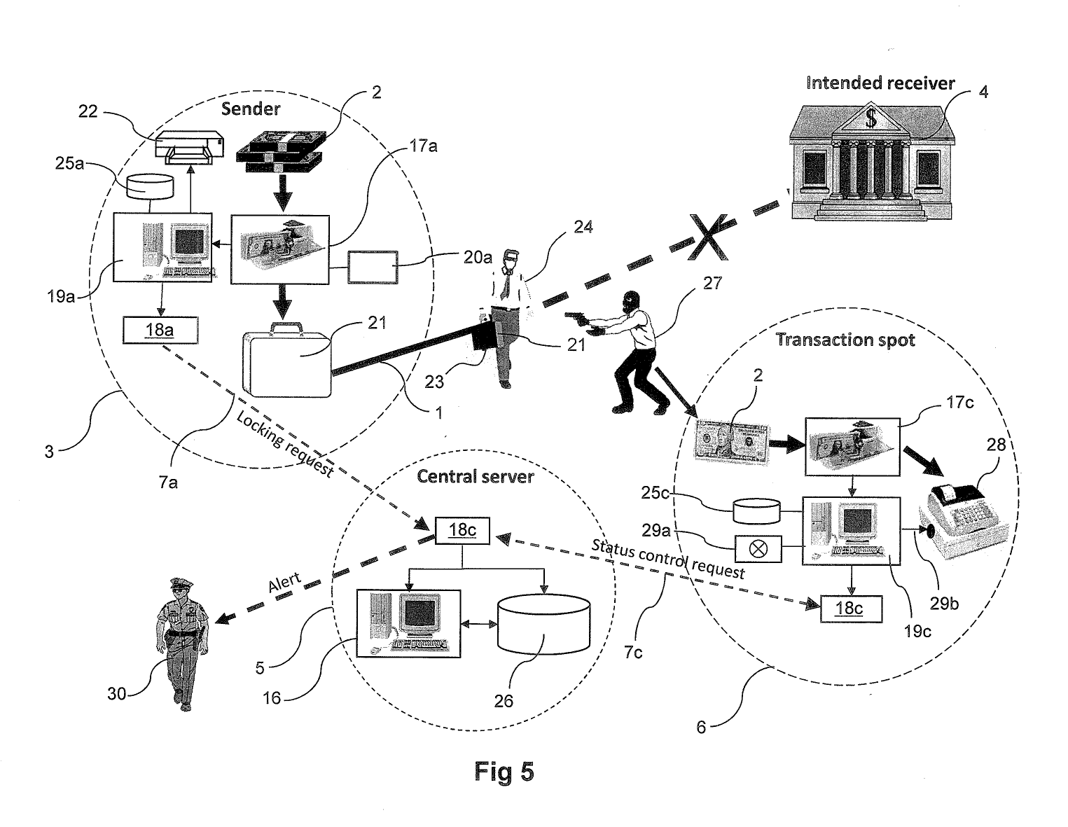

storage in the central server 5 of the auxiliary information T₁ and the banknote 2 identity, the Banknote-ID, to the effect that the banknote 2 is locked/non tradeable, so that the central server 5 on request emits response information to the effect that the banknote 2 is locked/non tradeable for the purpose of raising an alert, an alarm, or a blocking mechanism (see FIG. 5)

assignment of an explicit/implicit status, preferably in the central server 5, associated/related/stored with/to the banknote 2 identity, e.g. its Banknote-ID, for example, to the effect that the banknote 2 is tradeable, non-tradeable, locked, reported stolen or marked for tracking/tracing.

After receiving a transport or a period of storage the receiver 4 executes the following method steps:

recording/reading/imaging of a banknote 2 intended to be unlocked,

determination of the banknote's 2 identity, into a so-called Banknote-ID,

registration/generation of a second auxiliary information T₂ at/by the receiver 4, comprising at least information about the receivers 4 identity, key, code and/or other information that constitutes an unlocking verification UV, which is intended to fulfill/match the banknote 2 unlocking condition UV, defined by the sender 3 or predetermined in the central server 5 in order to unlock the banknote 2 or in order to relock the banknote 2,

generation of an unlock/relock request 9b-c including at least one banknote 2 identity, e.g. the Banknote-ID, and the auxiliary information T₂,

transfer of the unlock/relock request 9b-c to a central server 5 and/or a local memory 25b,

reception of the unlock/relock request 9b-c in the central server 5 including banknote 2 identity, e.g. the Banknote-ID, and the auxiliary information T₂,

checking by/in the central server 5 if the auxiliary information T₂ from receiver 4 fulfills/meet the unlocking conditions UV₁ previously defined in the auxiliary information T₁ from/by the sender 3 and/or fulfilling predetermined conditions stored in the central server 5, and if the conditions are met the lock/relock request 9b-c is executed in central server 5,

assignment of an explicit/implicit status, preferably in the central server 5, associated/related/stored with/to the banknote 2 identity, e.g. its Banknote-ID, for example, to the effect that the banknote 2 is tradeable, non-tradeable, locked, reported stolen or marked for tracking/tracing, or by the deletion of a Banknote-ID.

In summary, the system consists of, among other things:

at least one computer/processor 19a-c,

at least one communication device 18a-c,

a first reading device/banknote scanner 17a for banknote identification at/by the sender 3,

a second reading device/banknote scanner 17b for banknote identification at/by the receiver 4,

a third reading device/banknote scanner 17c for banknote identification at/by a transaction spot 6 (not shown),

a first registering device 20a for auxiliary information T₁ at/by the sender, 3,

a second registering device 20b for auxiliary information T₂ at/by the receiver 4,

at least one alarm/blocking/indicator/display unit (not shown),

at least one local memory device (not shown), and/or
at least one central server 5 comprising a central memory 26.

Before/during a cash transport from or storing cash at the sender's location 3, the system is characterized by:

that the first reading device 17a for banknote identification is arranged to image/detect a banknote 2 in order to determine the identity of the banknote 2, to a so-called Banknote-ID,

that the first registering device 20a is arranged to register/generate auxiliary information T₁,

that a computer/processor 19a is arranged to generate a locking request 9a comprising at least one banknote identity and auxiliary information T₁ and via a communication device 18a transfer the request to a central server 5 and/or a local memory 25a, whereby the banknote 2 is indicated as locked in the central server 5.

After receiving a transport/storage at the receiver 4 the system is characterized by:

that the second reading device 17b for banknote identification is arranged for imaging/detecting the received banknote 2 in order to establish its identity, to a so-called Banknote-ID,

that the second registering device 20b is adapted to register/generate auxiliary information T₂,

that a computer/processor 19b is arranged to generate an unlocking/relocking request 9b-c comprising at least one banknote identity and auxiliary information T₂, and transfer this request 9b-c via a communication device 18b to a central server 5 and/or to a local memory 25b,

that the central server 5 is arranged to check that the auxiliary information T₂ from the receiver 4 meet the conditions UV₁ set in the auxiliary information T₁ from the sender 3 and/or predetermined conditions UV₁ stored in the central the server 5, and if so perform the unlocking-/relocking request 9b-c.

FIG. 5 shows the same method and system as of FIG. 4. The difference between the figures is that in FIG. 5 illustrates the case where the carrier/courier 24 is subjected to a robbery in which the robber 27 grabs the banknote container 21 with banknotes 2. The money/banknotes 2 never reach the receiver 4 which thus fails to acknowledge/unlock the banknotes, and this in turn means that the robber 27 cannot use the money/banknotes 2 as payment.

A turnover spot 6, which can be a store or similar, is provided with a reading device/banknote scanner 17c, such as a fast scanner or a camera, which can be stationary or mobile. The reading device/banknote scanner 17c includes or is connected to a communication device 18c, by which the reading device/banknote scanner 17c can send and receive information from/to the central server 5. The reading device/banknote scanner 17c is arranged to at least scan a banknotes 2 unique identifying features, usually the serial number, denomination and currency.

In general each banknote 2 is checked in/by the central server 5 or a local memory 25c is if the banknote is tradeable/unlocked, and if so, the physical banknote 2 is put into the cash register 28 and the Banknote-ID is preferably assigned a status in the central server 5 and/or the local memory 25c to the effect that a banknote 2 with this Banknote-ID is not tradeable—you can also attach information about who the new owner of the banknote 2 is, so if the store would be robbed, later there will be records of the banknotes that were in the cash register and who the rightful owner is. If the customer that paid with cash/banknotes gets change from the cash register 28, then every banknote 2 given as change to the customer will be assigned a status in the central server 5 and/or local memory 25c to the effect that each banknote 2 with their respective Banknote-IDs are tradeable.

In the specific example with stolen banknotes a service request 7c including at least the Banknote-ID is sent wirelessly or by wire to the central server 5. This service request 7c may include a status control request 9d with the purpose of checking whether the banknote 2 is tradeable or not. When such a status control request 9d of the banknote 2 is sent to the central server 5, a response is returned indicating whether the banknote 2 is locked or tradeable. If the response indicates that the banknote 2 is locked/non-tradeable an alarm is raised overtly or covertly via an alarm unit 29a at the transaction spot 6. The transaction spot 6 can be equipped with a camera that takes a picture of the person 27 trying to turnover the locked banknote 2.

When the central server 5 sends a response which indicates that the banknote 2 is locked, an alarm can also be generated to an alarm recipient 30, for example the police or other authorities. This means that as soon as a locked banknote 2 is identified anywhere in the system, it can be immediately detected in real time.

The reading device/banknote scanner 17c at the transaction spot 6 may also be provided memory 25c is updated from the central server 5, either when new locked banknotes and/or stolen banknotes are registered in the central server 5 or at regular time intervals, e.g. once a day. When a status control request is done for verification of whether the banknote 2 is tradeable or not, this request may possibly be made against/fulfilled by the local memory 25c. This may be the case when the communication with the central server 5 is interrupted for any reason, or when one wants to reduce communication costs.

Thus, one can summarize the process at the transaction spot 6 by the following method steps:

recording/reading/imaging of a banknote 2 intended to circulated,

determination of the banknote's 2 identity, into a so-called Banknote-ID,

requesting information about whether the current banknote 2 is locked or tradeable from a local memory unit 25c and/or the central server 5,

reception in the central server 5 of a status control request 9d including a banknote 2 identity,

comparison of the banknote 2 identity against information stored in the central server 5,

checking the banknote's 2 explicit/implicit status, preferably in the central server 5, associated/related/stored with/to the banknote 2 identity, to determine if the banknote 2, for example is tradeable, non-tradeable, locked, stolen or marked for tracking,

transmission of a response / information indicating whether the banknote 2 e.g. is tradeable or not, for the purpose of activating an alert, an alarm or locking a cash register if the banknote 2 is locked/not tradeable.

activation of an indicator, an alarm unit 29a and/or activation of a lock mechanism 29b that prevents circulation of the banknote, when the response to the status control request indicates that the banknote 2 is not tradeable.

When an attempt to circulate a banknote 2 at a turnover spot 6 the system is characterized by:

that the third reading device 17c for banknote identification is arranged at the turnover location 6 for imaging/detecting the received banknote 2 in order to establish its identity, to a so-called Banknote-ID,

that a computer/processor 19c is arranged to compare the banknote 2 identity against the stored information regarding the banknotes 2 and their explicit/implicit status in the local memory unit 25c, and/or via a communication device 18c, make a request to the central server 5 whether the banknote 2 are tradeable,

that an alarm device 29a, locking mechanism 29b and/or indicator device is arranged to provide an indication and/or an alarm and/or activate a blocking device that prevents circulation of the banknote 2 when the banknote 2 identity is found in the local memory unit 25c and/or in the central server 5, and the meaning of this is that the banknote 2 is not tradeable.

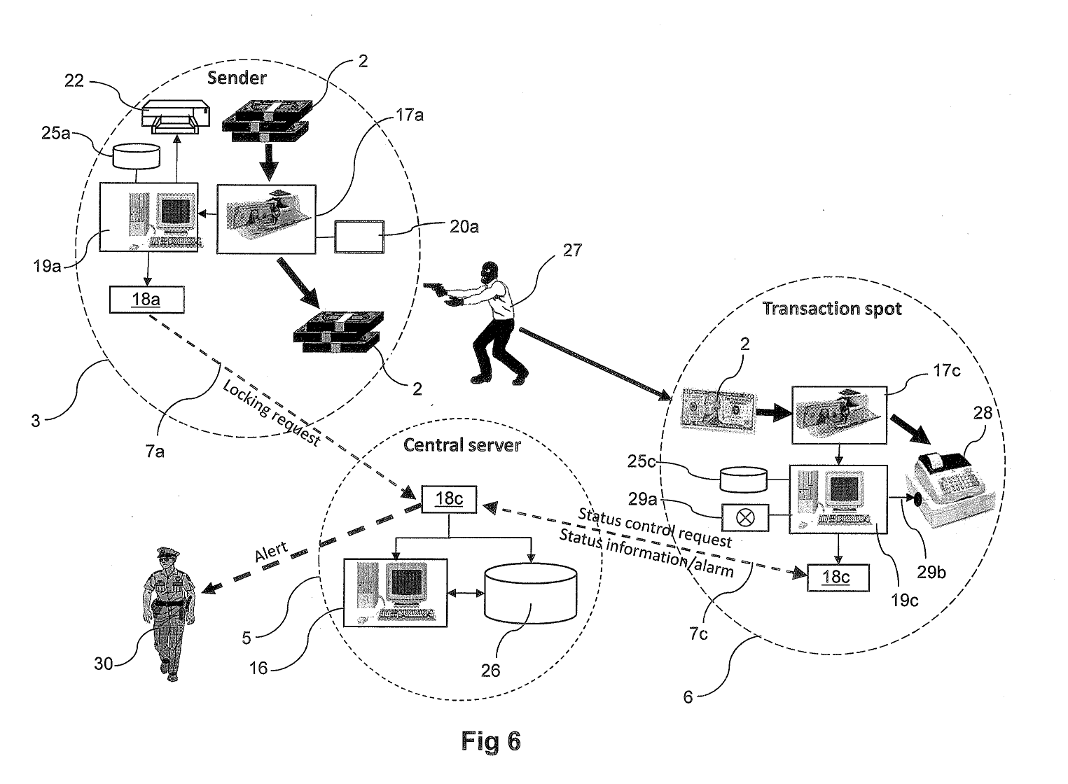

FIG. 6 shows the method and system of FIG. 4. The difference between the figures is that in FIG. 6, a robbery is executed against a place where banknotes are stored, e.g. a bank, cash depot or a store 3, 4, 6.

The banknote 2 is read/scanned on reception of the banknote 2, e.g. when receiving a cash transport or when accepting a banknote 2 as payment at a cash register. Each banknote 2 has been locked by a service request 7a for locking, and a lock request 9a has been transferred to the central server 5. Such a service request 7a can be requested immediately, at certain intervals, or on demand. The banknotes 2 are thus locked even when stored, and not only during transport.

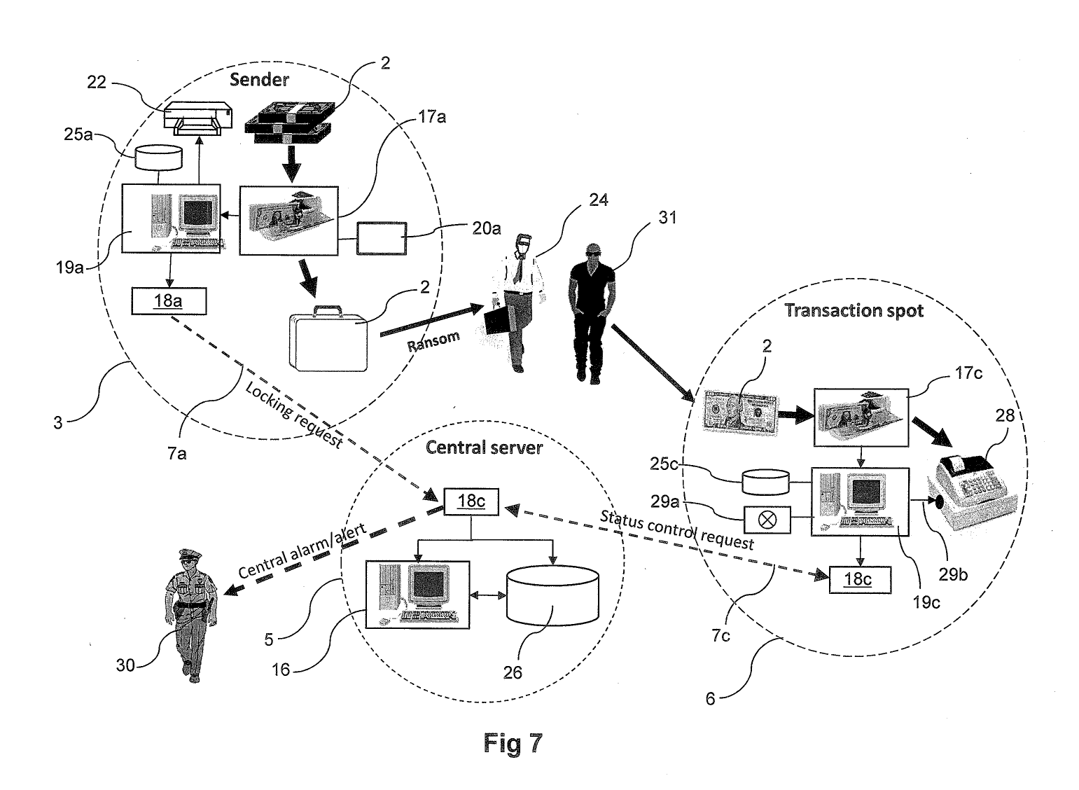

FIG. 7 shows the method and system of FIG. 4. The difference between the figures is that in FIG. 7 the banknotes 2 that are registered/scanned constitutes, for example, a ransom, and the banknotes 2 are not locked but instead marked for tracing in the central

When one of the banknotes marked for tracking is used as payment at a transaction spot 6, a service request 7c, is sent to the central server 5 to check if the banknote 2 is tradeable. In addition to this check, another check is performed in the central server 5 to see if the banknote's 2 ID is marked for tracking. If the check shows that the banknote's 2 ID is marked for tracking, no information about this state is sent back to the transaction spot 6 since the purpose is to track the banknote 2, meaning that the person 31 submitting the banknote 2 should not be notified in any way that the banknote 2 is tracked or has been discovered. No local alarm will be raised since one does not want to warn a potential criminal 31, but instead a central alarm will be raised so that an authority 30, for example police or other agencies can begin surveillance and investigation work without raising a criminal's 31 suspicions.

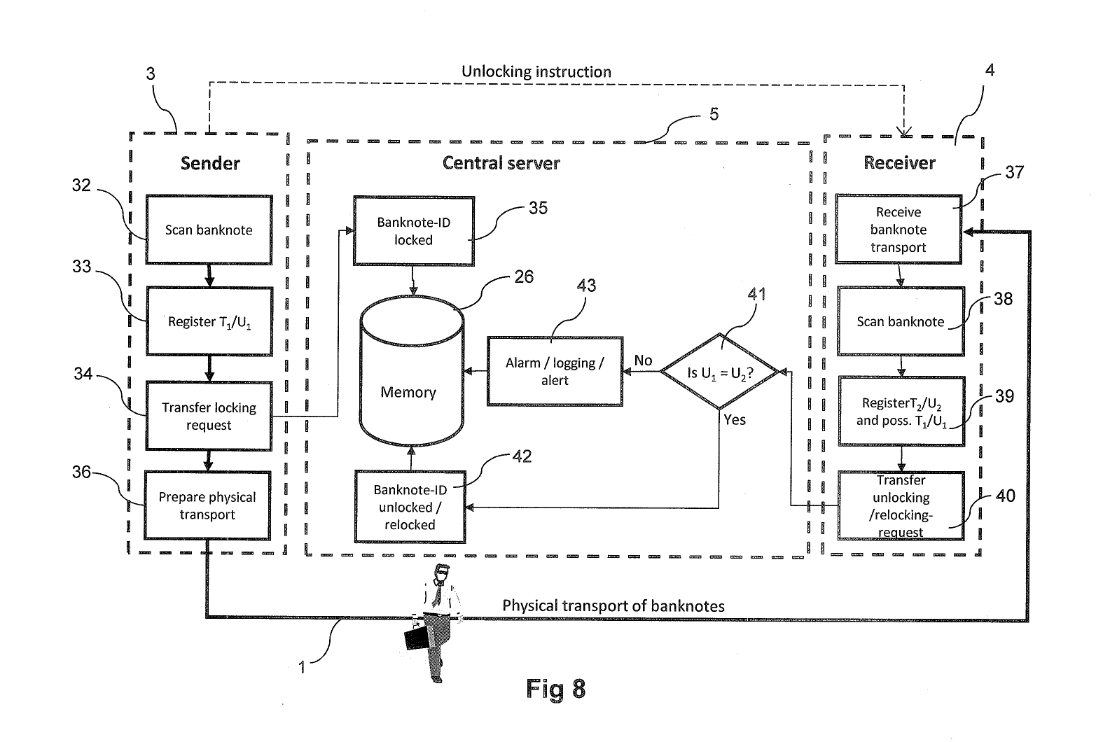

FIG. 8 shows a flow chart of an embodiment of the invention regarding the procedure for a normal cash transport between a sender 3 and a receiver 4.

The figure is mainly divided into three blocks, with a first block representing the activities of the sender 3, a second block representing activities in the central server 5 and a third block representing the activities of the receiver 4.

The sender 3 scans 32 the banknote 2 before transport/storage, records/generates 33 a first auxiliary information T₁, generates and transmits 34 a locking service request 7a for the scanned Banknote-IDs to the central server 5, the central server 5 receives the locking service request 7a and a status for the scanned Banknote-ID is changed/stored 35 to “locked” in a central memory 26 and an unlocking condition UV, and unlocking information U, in the first auxiliary information T, is stored and linked to the Banknote-ID in the memory. The sender 3 prepares 36 physical banknotes 2 for transport and may label/mark them so that it is clearly visible that the banknotes 2 are locked, and then a transporting agent 24 transports the physical banknotes 2 to the receiver 4. In case the banknotes 2 are only to be stored, then the sender 3 and receiver 4 can be the same, and the banknotes 2 need not be physically moved.

The receiver 4 receives 37 physical banknotes 2, scans 38 them, records/generates 39 a second auxiliary information T₂, generates and transmits 40 an unlocking service request 7b for the scanned Banknote-IDs to the central server 5, the central server 5 receives the unlocking service request and checks 41 if the unlocking match-information U₂ in the second auxiliary information T₂ matches the unlocking information U, that is stored in the central memory 26 for each Banknote-ID. If the unlocking match-information U₂ matches the unlock information U₁ then the status of the Banknote-ID is changed/stored 42 to “unlocked”/tradeable in the central memory 26. If the unlocking match-information U₂ does not match the unlocking information U₁ then the status of the Banknote-ID in the central memory 26 is not changed, and an alarm is emitted 43.

In another embodiment the unlocking condition UV₁ also includes an unlocking method US₁, and then the unlocking verification UV₂ has to include an unlocking method US₁, and to unlock a banknote 2 the unlocking match-information U₂ must match the unlocking information U₁ and the unlocking method US₁ specified in unlocking condition UV₁ must match the unlocking method US₂ specified in the unlocking verification UV₂.

In a third embodiment, the receiver 4 can automatically relock the banknotes 2 that have been received by supplementing the second auxiliary information T₂, which unlocks the banknotes, with an additional new first auxiliary information T₁ defining a new unlocking condition UV₁ which will relock the banknotes 2 immediately, and in effect the banknotes 2 are at no point in time tradeable since there is no gap in the procedure. In an example, a sender 3 sends an amount of banknotes 2 to a receiver 4, and during the transport the banknotes 2 are locked/non-tradeable. When the banknotes 2 are received at the receiver 4 the banknotes 2 are relocked and put into storage. If a robbery or burglary would occur at the receiver 4 these banknotes 2 are still locked/non-treadeable. If the receiver 4 wants to send the banknotes 2 to a new receiver 4 then the banknotes 2 are relocked so the new receiver 4 can later unlock/relock them.

A receiver 4 as well as a sender 3 may be a physical person, a legal entity, an organization, a physical unit e.g. deposit/ATM or such.

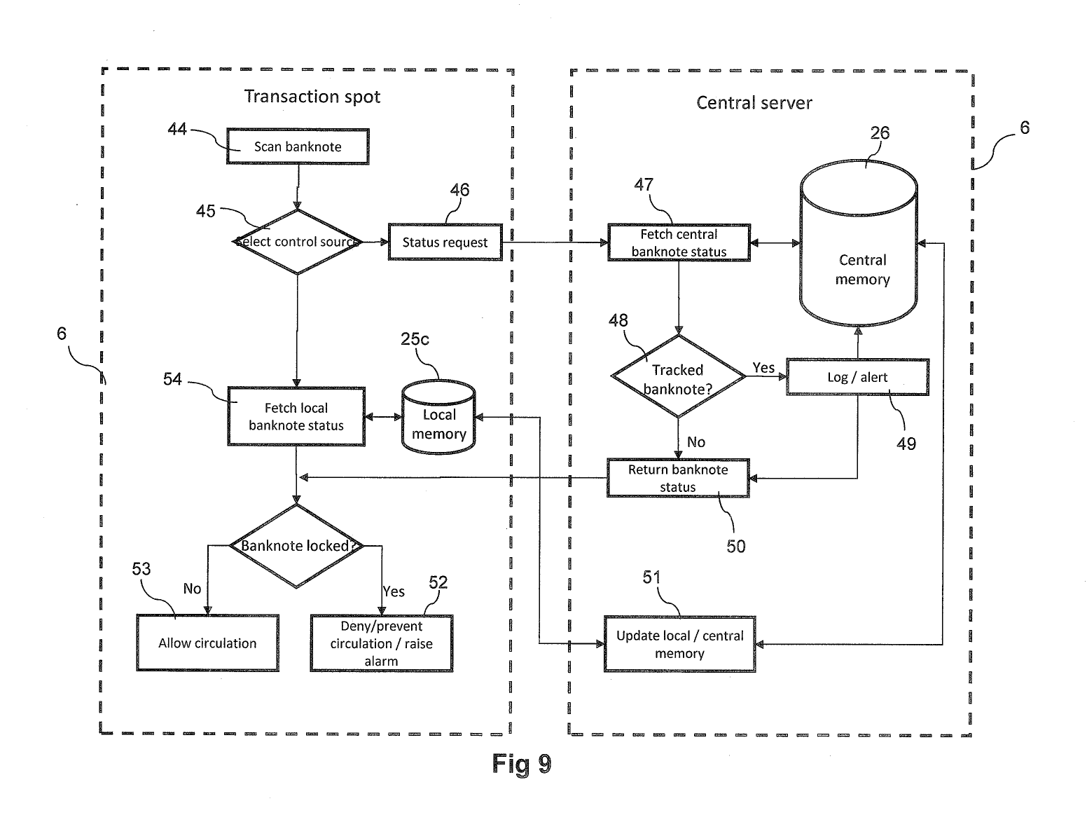

FIG. 9 shows a flow chart of an embodiment of the invention regarding the procedure for using a banknote as payment, for example in a store.

The figure is mainly divided into two blocks, a first block representing activities at a transaction spot 6, and a second block representing the activities at the central server 5.

When paying/using the banknote as payment, the banknote 2 is scanned 44, and a choice is made 45 either manually or automatically if the banknote's 2 status will be checked in a local 25c and/or the central memory 26. If the check is to be made in the central memory 26 then a service request 7c is generated 46 and transferred to the central server 5.

The central server 5 receives the service request 7c and checks 47 in the memory 26 if the banknote's 2 ID is registered, and if so, whether the banknote's 2 status is “locked”, “stolen” or “tradeable”, and possibly “tracked.”

If the banknote's 2 ID is found in the memory 26 and its status is “tracked” 48 then the banknote's 2 ID is stored 49 in a log, preferably in the memory 26, and/or an alarm 49 is raised/activated. It is important that a banknote 2 still can be used as payment when it is marked for tracking, without notifying the person submitting the banknote 2 that the banknote 2 is being tracked. In one embodiment, a banknote 2 can have one or more status codes assigned to it, such as that a banknote 2 are both marked for tracking and being locked, or being marked for tracking and being tradeable.

If the banknote's 2 ID is not found in the memory 26 or its status is “tradeable” then a response to the service request 7c is sent 50 back to the transaction spot 6 signaling that the banknote 2 can be circulated/used as payment 53.

If the banknote's 2 ID is found in the memory 26, and its status is “locked” or “stolen” or having a status with the meaning that the banknote is not tradeable, then a response to the service request 7c is sent 50 back to the transaction spot 6 signaling that the banknote 2 cannot be circulated/used as payment with the effect that the banknote is not accepted as valid payment 52, 29b and/or an alarm 29a is activated 52.

The reading device/banknote scanner 17c at the transaction spot 6 may also be provided with a local memory 25c which contains a regularly updated list of locked Banknote-IDs. The local memory 25c is updated 51 with information from the central memory 26 in the central server 5 either when new locked banknotes and/or stolen banknotes are registered in the central server 5 or at regular time intervals, such as once a day. When a request for verification of whether the banknote 2 is tradeable or not is performed, this test may be done at 54 in the local memory 25c. This may be the case when communication with the central server 5 is interrupted for any reason, or when you want to reduce communication costs.

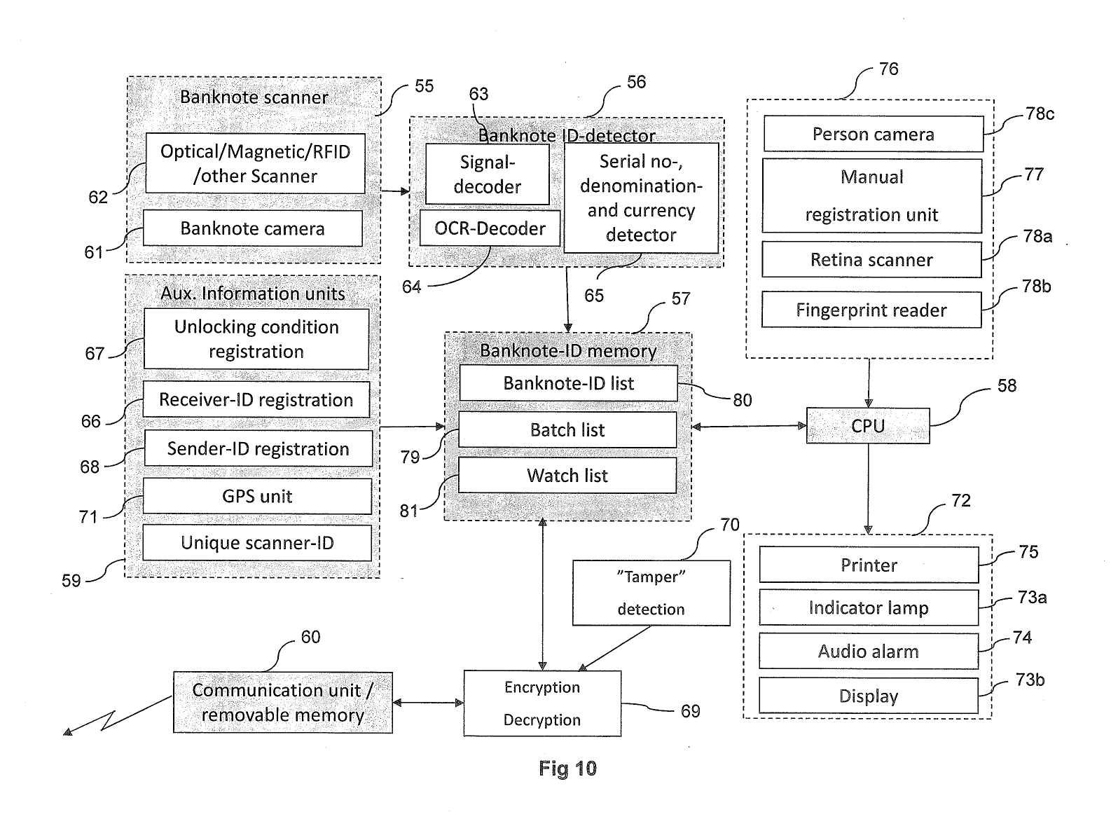

FIG. 10 shows a block schematic diagram of a banknote scanner according to the invention.

In an exemplary embodiment the banknote scanner comprises a banknote scanner/reader 55, a Banknote-ID detector 56, a Banknote-ID memory 57, a CPU 58, a device for the generation/registration of auxiliary information 59, such as intended receiver, and a communication device 60 alternatively a removable memory.

The banknote scanner/reader 55 contains for instance equipment for reading a banknote's code scanners, RFID detectors, and/or magnetic reading devices 62. The banknote reader/scanner 55 can be handheld or permanently mounted.

The Banknote-ID detector 56 consists of a device for decoding the signals from the 63 banknote reader/scanner 55, a unit for OCR recognition 64, and/or a device for detecting the denomination, the banknote serial number, the banknote type and/or currency 65. This information is combined into a unique Banknote-ID.

The banknote's 2 features are read/detected/imaged by the banknote scanner/reader 55, and the information is processed by the Banknote-ID detector 56 that generates a unique Banknote-ID which for example is stored in the Banknote-ID memory 57 or directly transmitted through the communication device 60 to e.g. the central server 5.

To this equipment other various additional equipment can be connected, such as a registering device 59, such as a keyboard for entering the receiver 66, the unlocking condition 67, the sender 68, the receiving account number etc., equipment such as a card reader to verify the authenticity of the person using the equipment, equipment such as an electronics unit 69 for encryption/decryption, equipment such as a shock/light/intrusion detector 70 in order to protect the device against tampering, equipment such as a GPS device 71 to indicate the physical position, and an embodiment for a banknote scanner/reader at transaction spot equipment for sounding an alarm 72 might be included. Equipment for sounding an alarm can for example be a device that emits a visual signal 73, an acoustic signal 74, an electronic signal, a printout 75 or similar. Equipment for verifying the authority 76 of the person using the equipment might be a keyboard 77 for entering a password, card readers, biometric devices 78a-c or similar.

The Banknote-ID memory 57 may preferably contain a list 80 of scanned Banknote-IDs, information about the scanned/read group of banknotes (a batch) 79, e.g. number of banknotes, total value, checksum over Banknote-IDs and such in the batch, and a watch list 81 of known locked Banknote-ID so that these can be detected without the need to send a service request to the central server 5.

The different devices/equipment/units can be integrated into one single physical device or be stand-alone devices that are connected by wire or wirelessly. The banknote scanner can also be connected to or include a device for verifying that the banknote 2 is genuine.

A banknote scanner with the above units can be an independent physical device but also be integrated into a cash register, a safety box, a cash deposit machine, an ATM or other equipment that manage/keep banknotes.

In summary the device is characterized by:

that a banknote reader 55 is arranged to detect and/or image each banknote 2,

that least one detector 56 is arranged to identify each banknote's existing serial number, denomination, banknote type and/or currency,

that a processor 58 is arranged to form a Banknote-ID unique for each banknote on the basis of these identified data

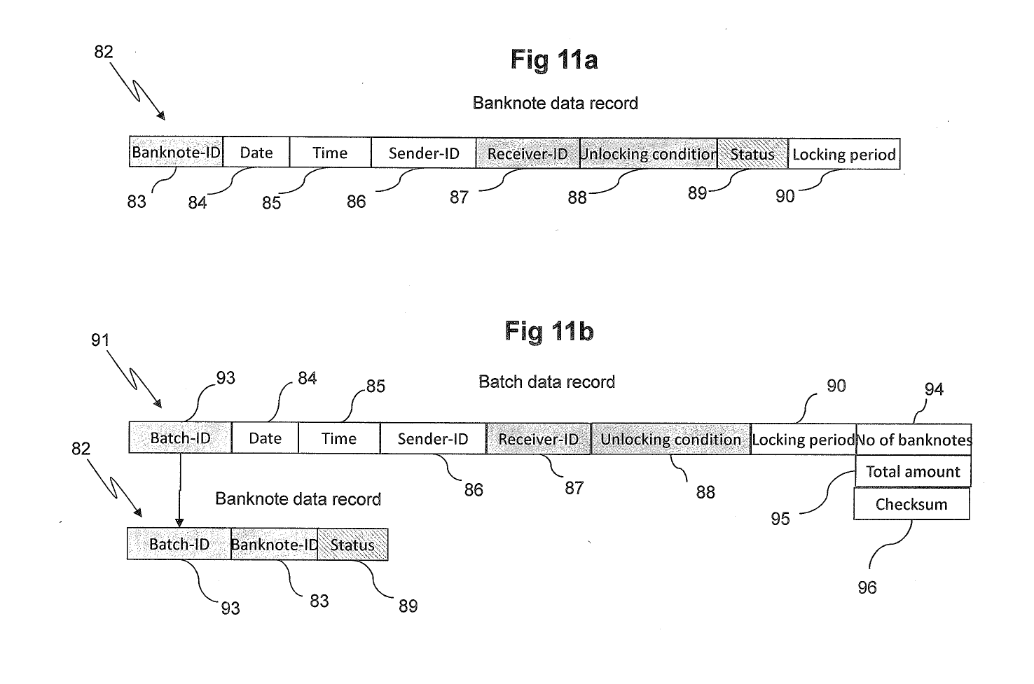

FIG. 11a shows an example of a banknote data record 82 stored in the central server 5 for a banknote.

This example relates to the data record details of a Banknote-ID 83 that is “locked”. The data record 82 includes, in this example, the data fields “Banknote-ID” 83, “Date” 84, “Time” 85, “Sender-ID” 86, “Receiver-ID” 87, “Unlocking condition” 88 and “Status” 89.

The “Banknote-ID” 83 has been read by the banknote scanner, “Date” 84, “Time” 85 and the “Sender-ID” 86 is automatically generated by/in the scanning process, “Receiver-ID” 87 is registered/selected manually during the scanning process and specifies who has the right/tion” 88 is specified by the sender/user in connection with the scanning process. “Status” 89 is set based on the type of service request received/performed, in this example “locked”, but can also be “tracked”, “stolen”, “unlocked”, “tradeable”, “time locked” or other variations. In one embodiment of the system, there may be a designated “locking period” 90 indicating a time period when a Banknote-ID is locked.

In another embodiment the field for “unlocking condition” 88 may be omitted if an unlocking condition has been predetermined/pre-stored and related to a particular receiver in order to enable that a particular receiver to unlock Banknote-IDs.

In another embodiment the field “Receiver-ID” 87 may be omitted if an unlocking condition has been specified that does not require that a particular receiver must unlock the stated Banknote-ID.

FIG. 11b shows an example of a batch data record 91 and the banknote data record 92 stored in the central server 5.

In the example in FIG. 11a the field “Date” 84, “Time” 85, “Sender-ID” 86, “Receiver-ID” 87 and “Unlocking condition” 88 was stored in the banknote data record 82. In an implementation where a performance increase in the central server 5 and/or a reduction in the need for data storage requirements and/or a specific organization of the information in the central server 5 to support certain functionality is desired or a particular development method needs to be supported, one can choose to organize the information in different ways. For example, in a relational database the information can be divided and stored in different tables, and how to divide/store the data is a design choice made by the implementer.

In another embodiment the fields “Date” 84, “Time” 85, “Sender-ID” 86, “Receiver-ID” 87 and “Unlocking condition” 88 may be stored in a separate batch data record 91, uniquely identified by a “Batch-ID” 93. This “Batch-ID” 93 can then be stored in a field in the banknote data record 92 as a reference to the fields “Date” 84, etc., and that information only needs to be stored once per batch data record 91 instead of for each banknote record 92. Such a batch data record 91 may preferably also contain summary information, such as the number of banknotes 94 in the batch, total amount 95 in the batch, and possibly a checksum 96.

In another embodiment the “Status” field 89 is emulated/implemented by having a banknote data record 92 or 82 stored in a particular register/memory/table, such as a register for Banknote-IDs with an implied status “locked”, another register for Banknote-IDs with an implied status “tradeable” or similar.

The fields “Date” 84 and “Time” 85 can be stored individually or in a composite form.

The “Status” 89 may contain a status code or contain plain text, and the status code in turn can refer to a table containing status information.

The description above is primarily intended to facilitate the understanding of the invention. The invention is therefore naturally thus not limited to the above embodiment forms but also other variants of the invention are possible and conceivable within the frame formed by the inventive idea and the appended claims. Thus, it is also possible that the banknotes 2 are not locked immediately, and that the Banknote-IDs only are stored by e.g. a sender 3, and that this information is transmitted to the central server 5 only after e.g. a confirmed/established robbery. It is also possible that the banknote 2 only is imaged and that the image information is stored and interpreted only when/if a robbery is confirmed/established. Such a system that is not locking the banknotes 2 immediately will, however, be less secure.

1. Method for reducing or eliminating the risk of robbery/theft, for example during transportation or storing banknotes, by scanning banknotes (2) prior to transport/storing and at the reception of the banknotes, and by verifying banknotes (2) when these are used in circulation, including, among other things reading devices/banknote scanners (17a-c) for banknote identification,
characterized by the following method steps:
before/during a transport from, or storage at the sender (3)
registering/reading/imaging of a banknote (2) that is intended to be locked,
determination the bank note (2) identity, to a so-called Banknote-ID,
registering/generation of auxiliary information (T₁) at the sender (3),
generation of a locking/blocking request (9a) comprising at least one banknote identity and auxiliary information (T₁),
transfer of this locking request (9a) to a central server (5) and/or a local memory (25a), whereby the banknote (2) is indicated as locked in the central server (5), after receiving the transport/storage at the receiver (4)
registering/reading/imaging of a banknote (2) that is intended to be locked/relocked,
determination the banknote (2) identity to a so-called Banknote-ID,
registering/generation of auxiliary information (T2) at the receiver (4),
generating of a unlocking-/relocking request (9b-c) comprising at least one banknote (2) identity and auxiliary information (T₂),
transfer of this unlocking-/relocking request (9b-c) to a central server (5) and/or to a local memory (25b),
checking of that the auxiliary information (T₂) from the receiver (4) fulfill the conditions (UV₁) set in the auxiliary information (T₁) from the sender (3) and/or the predetermined conditions (UV₁) stored in the central server (5), and if so, the unlocking-/relocking request (9b-c) is performed in the central server (5), attempting to make a purchase by means of a banknote (2) at a location where banknotes are handled/circulated (6)
registering/reading/imaging the banknote (2) that is to be circulated.
determination the banknote (2) identity, to a so-called Banknote-ID,
requesting to a local memory unit (25c) and/or the central server (5) if the present banknote (2) is blocked or tradeable,
generation of an indication, alarm and/or activation of a blocking device (29a-b) that prevents acceptance/circulating the banknote (2) when the response to the request means that the referenced banknote (2) is non tradeable.

2. Method according to claim 1,
further characterized by the method step:
assignment of an explicit/implicit status, preferably in the central server (5), associated/-related/stored with/to the banknote (2) identity, its Banknote-ID, for example to the effect that the banknote (2) is tradeable, non tradeable, blocked, stolen or marked for tracking.

3. Method of claim 1 or 2,
further characterized by the method step:
registering/generation of a first auxiliary information (T₁) at the sender (3), comprising at least an information of a predetermined receiver (4) such as the recipient identity (4), account information or similar, alternatively a key, a code and/or other unlocking condition (UV₁) that must be satisfied to make the banknote (2) tradeable or relocked.

4. Method according to any of the preceding claims,
further characterized by the method step:
registering/generation of a second auxiliary information (T₂) at the receiver (4), comprising at least one information of the receiver (4) identity, a key, a code and/or other information that provide an unlocking verification (UV₂) which is intended to meet/match the unlocking central server (5) to make the banknote (2) tradeable or to be relocked.

5. Method according to any of the preceding claims,
further characterized by the method step:
checking the explicit/implicit banknote (2) status, preferably at the central server (5), associated/related/stored with/to the banknote (2) identity, its Banknote-ID, to determine if the banknote (2) for example, is tradeable, non tradeable, locked, stolen or marked for tracking.

6. Method for locking of one or more banknotes (2) at a sender (3) in order to make the banknotes (2) unusable for trade, before and/or during transport/storing banknotes (2), comprising among other things a reading device/banknote scanner (17a) for banknote identification,
characterized by the following method steps:
registering/reading/imaging of a banknote (2) at the sender (3) prior to/during a transport/storage,
determination the banknote (2) identity, to a so-called Banknote-ID,
registering/generation of auxiliary information (T₁),
generation of a locking request (9a) comprising at least one banknote identity and the auxiliary information (T₁), and
transfer of this locking request (9a) to a central server (5) and/or to a local memory (25a), with the purpose that the banknote (2) shall be indicated as locked, in the central server (5).

7. Method according to claim 6,
further characterized by the method step:
assigning of an explicit/implicit status, preferably in the central server (5), associated/related/stored with/to the banknote (2) identity, its Banknote-ID, for example with the meaning that the banknote (2) is tradeable or non tradeable, locked, stolen or marked for tracking.

8. The method of claim 6 or 7,
further characterized by the method step:
registering/generation of a first auxiliary information (T₁) at the sender (3), comprising at least an information of a predetermined receiver (4) such as the receivers (4) identity, account information or similar alternative a key, a code and/or other unlocking condition (UV₁) that must be met in order to make the banknote (2) tradeable or relocking it.

9. Method for unlocking/relocking of one or more banknotes (2) at a receiver (4) in order to make the banknotes (2) tradeable/relocked, after receiving/storing the banknotes (2), comprising among other things a reading device/banknote scanner (17b) for banknote identification,
characterized by the following method steps:
registering/reading/imaging a banknote (2) that is going to be unlocked/relocked,
determination the banknote (2) identity, to a so-called Banknote-ID,
registering/generation of auxiliary information (T₂) at the receiver (4),
generation of a unlocking/relocking request (9b-c) comprising at least one banknote (2) identity and the auxiliary information (T₂),
transfer of this unlocking/relocking request (9b-c) to a central server (5) and/or to a local memory (25b) with the purpose of checking whether the auxiliary information (T₂) from the receiver (4) meet the conditions (UV₁) indicated in the auxiliary information (T₁) from the sender (3) and/or the predetermined conditions (UV₁) stored in the central server (5), with the purpose to perform the unlocking/relocking request (9b-c) in the central server (5)

10. The method of claim 9,
further characterized by the method step:
assigning of an explicit/implicit status, preferably in the central server (5), associated/-related/stored with/to the banknote (2) identity, its Banknote-ID, for example with the meaning that the banknote (2) is tradeable, non tradeable, locked, stolen or marked for tracking.

11. The method of claim 9 or 10,
further characterized by the method step:
registering/generating a second auxiliary information (T₂) at the receiver (4), comprising at least an information of the receiver (4) identity, a key, a code and/or other information that provide an unlocking verification (UV₂) that is intended to meet/match the banknote (2) unlocking condition (UV₁) specified by the sender (3) or predetermined in the central server (5) in order to make the banknote (2) to be usable for trade or for relocking.

12. Method for checking the status of a banknote (2) in the central server (5) and/or in a local memory (25c) at an attempt to trade the banknote (2) at a turnover location (6) and if the banknote (2) is not indicated as usable for trade, trigger an activity including, comprising among other things a reading device or a banknote scanner (17c) for banknote identification and an alarm/locking/indicator device (29a-b),
characterized by the following method steps:
registering/reading/imaging of the banknote (2) that is intended to be circulated,
determining the banknote (2) identity, to a so-called Banknote-ID,
requesting, to a local memory unit (25c) and/or the central server (5), if the banknote (2) is locked or tradeable,
delivery of an indication, an alarm and/or activation of a blocking device (29a-b) that prevents acceptance/circulating the banknote (2) when the response to the request means that the referenced banknote (2) is not usable for trade.

13. The method of claim 12,
further characterized by the method step:
checking the explicit/implicit the banknote (2) status, preferably in the central server (5), associated/related/stored with/to the banknote (2) identity, its Banknote-ID, in order to determine if the banknote (2) for example, is tradeable, non tradeable, locked, stolen or marked for tracking.

14. Method for locking of one or more banknotes (2) in a central server (5) in order to make the banknotes (2) non tradeable, prior to transporting/storing banknotes (2),
characterized by the following method steps:
receiving of a locking request (9a) comprising the banknote (2) identity, the Banknote-ID, and an auxiliary information (T₁) ,
in the central server (5) store the auxiliary information (T₁) and the banknote (2) identity with the meaning that the banknote (2) is locked/non tradeable, so that the central server (5) upon request provide response information with the meaning that the banknote (2) is locked/non tradeable with the intention to activate an indication, an alarm or a blocking device (29a-b).

15. The method of claim 14,
further characterized by the method step:
assigning of an explicit/implicit status, associated/related/stored with/to the banknote (2) identity, its Banknote-ID, for example with the meaning that the banknote (2) is tradeable, non tradeable, locked, stolen or marked for tracking.

16. The method of claim 14 or 15
storing of an auxiliary information (T₁) at locking, comprising at least an information of a predetermined receiver (4) such as the receiver (4) identity, account information or similar information, alternatively a key, a code and/or other unlocking condition (UV₁) that must be met in order to make the banknote (2) usable for trade or for relocking.

17. Method for unlocking/relocking of one or more banknotes (2) in a central server (5) in order to make the banknotes usable for trade/relocking, after receiving/storing the banknotes (2),
characterized by the following method steps:
receiving an unlocking/relocking request (9b-c) including the banknote (2) identity, the Banknote-ID, and an auxiliary information (T₂) ,
checking that the auxiliary information (T₂) in the unlocking/relocking request (9b-c) meet the conditions (UV₁) set in a previous locking request (9a) in the stored auxiliary information (T₁) for the referenced Banknote-ID and/or predetermined conditions (UV₁) stored in the central server (5), and if so the banknote is unlocked/relocked.

18. The method of claim 17,
further characterized by the method step:
assigning of an explicit/implicit status, associated/related/stored with/to the banknote (2) identity, its Banknote-ID, for example with the meaning that the banknote (2) is tradeable, non tradeable, locked, stolen or marked for tracking, or by that the Banknote-ID is erased.

19. The method of claim 17 or 18,
further characterized by the method step:
receiving of an auxiliary information (T₂) at unlocking/relocking, comprising at least an information of the receiver (4) identity, a key, a code and/or other information that provide an unlocking verification (UV₂) which is intended to meet/match the banknote (2) unlocking condition (UV₁), indicated/stored at an earlier locking request (9a), alternatively predetermined in the central server (5), in order to make the banknote (2) tradeable or for relocking.

20. Method for responding to a request in a central server (5) whether a banknote (2) is tradeable or not,
characterized by the following method steps:
receiving a checking request (9d) including the banknote (2) identity, the Banknote-ID,
comparing the referenced banknote (2) identity, against information stored in the referenced central server (5),
transmission of response information with the intention that the banknote (2) e.g. is tradeable or not with the purpose to activate an indication, an alarm, or a blocking device (29a-b) if the banknote (2) is locked/non tradeable.

21. System for reducing or eliminating the risk of robbery/theft, for example during transport (cash in transit, CIT) or storage of banknotes, by scanning the banknotes (2) prior to the transport/storing as well as at the reception of the banknotes and by verifying banknotes (2) in an attempt to be circulated, comprising
at least one computer/processor (19a-c),
at least one communication device (18a-c),
a first reading device (17a) for banknote identification at the sender (3),
a second reading device (17b) for banknote identification at the receiver (4),
a third reading device (17c) for banknote identification at a turnover spot (6),
a first registering device (20a) for auxiliary information (T₁) at the sender (3),
at least one alarm/block/indicator device (29a-b),
at least one local memory unit (25a-c), and/or
at least one central server (5)
characterized by:
before/during a transport from or storing at the sender (3)
that the first reading device (17a) for banknote identification is arranged to image/detect a banknote (2) in order to determine the banknote (2) identity, to a so-called Banknote-ID,
that the first reading device (20a) is arranged to register/generate auxiliary information (T₁),
that a computer/processor (19a) is arranged to generate a locking request (9a) comprising at least one banknote identity and auxiliary information (T₁) and via a communication device (18a) transfer the referenced request to a central server (5) and/or a local memory (25a), whereby the banknote (2) is indicated as locked in the central server (5), after receiving a transport/storage at the receiver (4)
that the second reading device (17b) for banknote identification is arranged to imaging/detecting the received banknote (2) in order to establish its identity, to a so-called Banknote-ID,
that the second registering device (20b) is adapted to register/generate auxiliary information (T₂),
that a computer/processor (19b) is arranged to generate an unlocking/relocking request (9b-c) comprising at least one banknote identity and auxiliary information (T₂), and transfer this request (9b-c) via a communication device (18b) to a central server (5) and/or to a local memory (25b),
that the central server (5) is arranged to check that the auxiliary information (T₂) from the receiver (4) meet the conditions (UV₁) set in the auxiliary information (T₁) from the sender (3) and/or predetermined conditions (UV₁) stored in the central the server (5), and if so perform the unlocking-/relocking request (9b-c), at an attempt to circulate a banknote (2) at a turnover spot (6)
that the third reading device (17c) for banknote identification is arranged at the turnover spot (6) for imaging/detecting the received banknote (2) in order to establish its identity, to a so-called Banknote-ID,
that a computer/processor (19c) is arranged to compare the banknote (2) identity against the stored information regarding the banknotes (2) and their explicit/implicit status in the local memory unit (25c) and/or via a communication device (18c) make a request to the central server (5) whether the banknote (2) is tradeable,
that an alarm/lock/indicator device (29a-b) is arranged to provide an indication and/or an alarm and/or activate a blocking device that prevents the banknote (2) circulation when the banknote (2) identity is found in the local memory unit (25c) and/or in the central server (5), and the meaning of this is that the banknote (2) is non tradeable.

22. System for locking of one or more banknotes (2) at a sender (3) in order to make the banknotes (2) non tradeable , prior to or during transport/storage of the banknotes (2), comprising
a computer/processor (19a),
a communication device (18a),
a reading device (17a) for banknote identification,
a registering device (20a) for additional information (T₁)
characterized by:
that the reading device (17a) for banknote identification is arranged for imaging/detecting a banknote (2) in order to establish its identity, a so-called Banknote-ID,
that the registering device (20a) is arranged to register/generate auxiliary information (T₁),
that the computer/processor (19a) is arranged to generate a locking request (9a) comprising at least a banknote identity and auxiliary information (T₁) and via the communication device (18a) transfer this request (9a) to a central sensor (5) and/or to a the central server (5).

23. System for locking/relocking of one or more banknotes (2) at a receiver (4) in order to make the banknotes (2) tradeable/relocked, after receiving/storing the banknotes (2), comprising
a computer/processor (19b),
a communication device (18b),
a reading device (17b) for banknote identification,
a registry device (20b) for auxiliary information (T₂)
characterized by:
that the reading device (17b) for banknote identification is arranged for imaging/detecting the received banknote (2) to establish its identity, to a so-called Banknote-ID,
that the registering device (20b) is arranged to register/generate auxiliary information (T₂),
that a computer/processor (19b) is arranged to generate an unlocking/relocking request (9b-c) comprising at least one banknote identity and auxiliary information (T₂),
and via the communication device (18b) transfer this request (9b-c) to a central server (5) and/or to a local memory (25b) with the purpose to check whether the auxiliary information (T₂) from the receiver (4) meets the conditions (UV₁) in the auxiliary information (T₁) from the sender (3) and/or in the predetermined conditions (UV₁) stored in the central server (5), and if so execute the unlocking/relocking request (9b-c) in the central server (5).

24. System for checking the banknote (2) status in the central server (5) and/or in a local memory (25c), at an attempt to circulate a banknote (2) in a turnover spot (6), comprising
a computer/processor (19c),
a communication device (18c),
a reading device (17c) for banknote identification,
at least one alarm/lock/indicator device (29a-b)
characterized by:
that the display device (17c) for banknote identification is arranged at the turnover spot (6) for imaging/detecting the received banknotes (2) to establish its identity, to a so-called Banknote-ID,
that the computer/processor (19c) is arranged to compare the banknote (2) identity to stored information regarding banknotes (2) and their explicit/implicit status in a local storage unit (25c) and/or via the communication device (18c) submit a request to the central server (5) whether the banknote (2) is tradeable,
that the alarm/lock/indicator device (29a-b) is arranged to provide an indication and/or an alarm and/or activate a blocking device, if the banknote (2) is non tradeable.

25. Device for reading one or more banknotes (2)
characterized by:
that a banknote reader (55) is arranged to detect and/or image each banknote (2),
that at least one detector (56) is arranged to identify each banknotes (2) existing serial number, denomination, banknote type and/or currency,
that a processor (58) is arranged on the basis of these identified data forming a Banknote-ID, unique for each banknote.
